(19) United States
(12) Patent Application Publication
(10) Pub. No.: US 2005/0143174 A1
(43) Pub. Date: Jun. 30, 2005

(54) Systems and methods for data mining via an on-line, interactive game

(76) Inventors: Daniel Philip Goldman, Brooklyn, NY (US); Timothy Lane Seaton, Topanga, CA (US)

Correspondence Address: PAUL, HASTINGS, JANOFSKY & WALKER LLP, P.O. BOX 919092, SAN DIEGO, CA, 92191-9092, US

(21) Appl. No.: 10/921,395

(22) Filed: Aug. 19, 2004

Related U.S. Application Data
(60) Provisional application No. 60/496,704, filed on Aug. 19, 2003.

(51) Int. Cl. A63F 13/00

(52) U.S. Cl. 463/42; 463/39; 463/40; 463/41

(57) ABSTRACT

Systems and methods for obtaining data using participants in a virtual gaming environment is provided. This method provides a simulated market economy with multiple participants. The simulated market economy is supported by instant messaging as a communications platform. The participants are enabled to obtain virtual resources available from the simulated market economy by, for example, (i) using virtual currency to purchase an item from a virtual store, (ii) by purchasing the item from another participant in a simulated secondary market purchase, or (iii) by trading one item from the participant's inventory for another item in a simulated barter transaction. Once a participant obtains a virtual resource, a signal is generated. This signal is transmitted to other participants through the instant messaging platform to indicate that such virtual resource has been obtained. Data regarding behavior of the participants in the simulated market economy is collected.

### RELATED APPLICATION INFORMATION

This application claims priority under 35 U.S.C. §119(e) to Provisional Application 60/496,704, entitled “IM Star Functional Specification” filed Aug. 19, 2003 and is closely related to the application entitled “Systems and Methods for a Role-Playing Game Having a Customizable Avatar and Differentiated Instant Messaging Environment,” concurrently filed on Aug. 19, 2004.

### BACKGROUND

1. Field of the Inventions

The present invention relates to on-line role-playing game systems, instant messaging systems and data mining methods.

2. Background Information

A. Role-playing Games

Role-playing games (“RPGs”) are a form of interactive and collaborative entertainment. In RPGs, each player controls the actions of one or more characters. Players develop unique characters based on choices they make. Typically, characters develop by accumulating virtual resources that may comprise, for example, a virtual good such as a weapon or a piece of armor, or a raw material with which to build a weapon or a piece of armor, or an object of virtual currency that can be exchanged with other participants in the virtual market or with virtual merchants for other virtual resources. Players typically amass various objects and abilities through extended play. The rules for how quickly, how many and what type of abilities and objects a character may gain usually involve several ratings or statistics (such as strength, dexterity, intelligence, charm, etc.). These ratings determine the outcome of various chance or future events that lead to new objects and abilities. In RPGs, players generally do not compete against each other, as in sports, board games and card games. The only way to “lose” an RPG is to not enjoy it.

The popular term for the current, Internet driven, multi-player computer online roleplaying game is MMORPG, or Massively Multiplayer Online Role-Playing Game. MMORPGs (e.g. Everquest, Ultima Online, Asheron's Call, Star Wars: Galaxies, Planetside, Anarchy Online, City of Heroes, Lineage, The Sims Online, etc.) are networked over the internet, and incorporate broader social interaction than traditional table-top role-playing games, since there can be an unlimited number of participants. Participants in MMORPGs use common software which is, for example, installed via CD-Rom or downloaded from the Internet to the participant's computer. Participants communicate with other participants and an MMORPG server, for example, over the internet. Users communicate via public, or scrolling chat, while objects (characters, equipment, monsters, etc.) are represented graphically within a shared 3D virtual environment on each player's computer screen. It is difficult for the average person to participate in the majority of MMORPGs, given the need to learn complex rules and accept a certain established social etiquette to play them.

A less common form of online role-playing game (“ORPG”) does not involve direct interaction between players, but rather one-on-one interaction between the player and his or her character (e.g. Neopets). This type of web-based ORPG requires no proprietary software for a user to be able to play; rather, a PC with an Internet connection and a web-browser are all that is required. However, such web-based ORPGs lack the multi-user interaction and communication that enhance MMORPG game-play. Participants do not chat directly with one another; rather they post messages to public message boards. Nevertheless, NeoPets has a much larger user base than any MMORPG, in part because it requires no specialized software or hardware and is easy to use.

Most MMORPGs involve a fantasy theme that characterizes the virtual environment and the nature of game-play. For example, EverQuest, Ultima Online, Asheron's call and many others revolve around medieval fantasy, similar to Dungeons and Dragons, while Star Wars Galaxies and Planetside involve space fantasy. Although the number of registered users of many MMORPGs are in the hundreds of thousands, the business model for MMORPGs is limited to subscriptions because advertising within the MMORPG environment is not appropriate due to the strict thematic concepts.

A disadvantage of the typical MMORPG is that it requires many years to develop, involving great expense (typically $25 million and up) to design and program large scale, proprietary client-server networking software. Since there are currently no standard tools for the turn-key development of MMORPGs, and since MMORPGs require the delivery of a high level of real-time interaction between players sharing a 3D virtual environment, developers must develop proprietary networking and transport protocols to provide the real-time interaction associated with MMORPGs.

Another disadvantage of typical MMORPGs is that they require a very large time commitment from users. Research shows that the average MMORPG user spends 20 hours per week engaged in a MMORPG. Many people cannot become involved in MMORPGs, because they do not want to sacrifice time for other activities in order to devote time to both learning how to play and to playing an MMORPG.

B. Instant Messaging

Instant Messaging is a widely recognized system of online communication that allows a user to create a list of other users with whom he or she wishes to communicate; when a user from his or her list is on line, the service alerts the user and enables immediate contact with the other user. While instant messaging has primarily been a proprietary service offered by Internet service providers such as AOL, MSN, Yahoo and ICQ, businesses are starting to employ instant messaging to increase employee efficiency and make expertise more readily available to employees. Instant messaging is sometimes confused with “chat.” Chat takes place in “chat rooms,” which are places or pages in a web site or online service where people can communicate with each other by typing messages which are displayed almost instantly on the screens of others who are in the same “chat room.” A number of customers can be in the public chat rooms at any given time, which are frequently monitored by the provider of the chat room for illegal activity and or inappropriate language, through systems operators (SYSOP).

Unlike chat, instant messaging technology requires each user to set up an account, choose a screen name, and build a “buddy list” of other people's screen names with whom they want to communicate. The instant messaging technology notifies a user when any of the people on their buddy list are online, allowing the user to communicate one-on-one in real time. One of the benefits of instant messaging is the way it combines the live, “real time” nature of chat rooms with the direct contact of e-mail. IM software connects users who have all agreed to be part of the same group. The ability to easily see whether a chosen friend or co-worker is connected to the Internet is commonly referred to as “presence.” Instant messaging differs from ordinary e-mail in the immediacy of the message exchange and also makes a continued exchange simpler than sending e-mail back and forth. Most exchanges are text-only, however, most instant messaging applications allow users to exchange files, similar to the way one can attach a file to an e-mail.

The communication advantages offered by instant messaging have resulted in the remarkable growth of instant messaging services. According to one study, there are over 590 million users of instant messaging worldwide, and over 2.3 billion instant messages per day sent on AOL's network alone. Nevertheless, instant messaging remains relatively untapped by advertisers.

Internet and on-line computer games are two venues that advertisers have been exploiting in increasing numbers. According to the non-profit Pew Internet and American Life Project, over 60% of Americans now have Internet access and 40% of Americans have been online for more than three years. According to a recent study of 13-24 year olds by Teen Research Unlimited and Harris Interactive, young people spend an average of 16.7 hours a week online, excluding time spent on e-mail, compared with 13.6 hours a week spent watching TV. The study also found that today's teens are adept at multitasking, as most watch television while instant messaging, e-mailing their friends, or surfing the internet.

In an increasingly competitive, fragmented and ubiquitous media market targeting multi-tasking consumers, it is becoming harder for marketers to build and maintain brand loyalty. One response to the new challenge of delivering effective brand messages has been to get the consumers to “play” with brands, using so-called “advergames.” The advergaming sector is an area in which numerous companies are generating revenues, and helping advertisers to exhibit their brands within customized, relevant online entertainment. In doing so, advertisers not only build brand exposure, but can track user behavior and mine data to target consumers more effectively. Burger King, Coca-Cola, Chrysler, Hewlett-Packard, Kmart, M&M/Mars, Pepsi and other marketers have used advergames to expose consumers to their brands. One example is a game that Nextel recently paid to launch on SportsLine.com, in which players throw a ball to a moving receiver, while Nextel signs appear in the virtual stands. Another example is Chrysler's “Get Up and Go” advergame created by YaYa media, which attracted 40,000 players in its first week of introduction, with an average player age of 45, of which 42 percent were women. Details of this game is provided on http://www.yaya.com/case.html. A significant percentage of these players expressed interest in learning more about Chrysler's products.

One limitation of current advergames is that they are simple, session-based games that are played by a single player on a website. They lack the persistent, multi-user community of online role-playing games, and are unlikely to sustain a users' interest over time. They are typically built to promote or advertise a single product. They do not generate a repeat community of connected users who can then be exposed as a group to multiple advertising images over extended periods of time, while simultaneously engaging in active chat discussions.

To date, the advertising industry has failed to capture the benefits available through instant messaging and thus experienced difficulty in monetizing instant messaging services. The major IM providers have attempted to deliver advertising within their instant messaging systems, however this advertising is interruptive in nature (such as banners, pop-up ads or branded borders around the instant messaging window). This form of advertising is not valuable for instant messaging users because it is not helpful for communicating via instant messaging. As an advertising medium, interruptive advertising is not effective because users who are engaged in communication with each other are not inclined to have their conversations interrupted in order to view an advertisement.

In other attempts to generate revenues, some instant messaging service providers, such as MSN, Yahoo, and AOL offer games linked to their instant messaging platform. For example, AOL Instant Messenger (“AIM”) allows users to link to a game of chess or checkers with a chat partner. This service is provided by a third party (Wild Tangent). Thus far, the games offered with the instant messaging services are simple, casual, session-based, single or two-player games such as checkers. Some of the instant messaging service providers are offering both sponsored and subscription versions of customized “emoticons” (little emotive icons such as a smiley face or a “thumbs up”) and themed background screens along with instant messaging. For example, users of AOL's 9.0 service can download free, themed “backgrounds” for their IM windows, called AIM Expressions, some of which are sponsored by marketers. For $1.95 per month, users may download additional AIM Expressions that are not available for free. Other instant messaging service providers have partnered with advertisers and are including thirty second TV-style commercials played in the instant messaging window.

What is needed then is a system and method for combining the multiplayer role-playing interaction of MMORPGs with instant messaging to create a robust, revenue generating instant messaging environment, for example, an environment configured to provide advertising in the form of graphical branded objects that are part of a role-playing game, wherein data is collected with respect to user behaviors relative to the branded products. Furthermore, a system and method is needed for combining the multiplayer role-playing interaction of MMORPGs with instant messaging that allows a user to create a list of other users with whom he or she wishes to communicate, in a thematic environment where real-life brands can be inserted as role-playing objects, which are an effective form of advertising when they are used and discussed by participants in a role-playing experience.

### SUMMARY OF THE PRESENT INVENTION

The present invention features various methods and systems for role-playing games, instant messaging and advertising, which overcome the disadvantages and shortcomings of the existing methods and systems by providing an environment in which multiple participants can participate in graphical role-playing games facilitated by instant messaging and characterized by a simulated market, in which data relating to the participants behavior is tracked.

In one aspect, the present invention features a method for obtaining data. This method provides a simulated market economy with multiple participants. The simulated market economy is supported by instant messaging as a communications platform. The participants are enabled to obtain virtual resources available from the simulated market economy by, for example, (i) using virtual currency to purchase an item from a virtual store in a simulated retail purchase, (ii) by purchasing the item from another participant in a simulated secondary market purchase, or (iii) by trading one item from the participant's inventory for another item or items in the inventory of another participant in a simulated barter transaction. Once a participant obtains a virtual resource, a signal is generated. This signal is transmitted to other participants through the instant messaging platform to indicate that such virtual resource has been obtained. Data regarding behavior of the participants in the simulated market economy is collected.

Data regarding behavior of the participants in the simulated market economy may be aggregated data or individualized data. For example, in one embodiment, data regarding acquisition and/or usage of the virtual resources by an individual participant is gathered. In another embodiment, data relating to preferences of an individual participant of one virtual resource over another virtual resource is gathered.

In one embodiment, the simulated market economy reflects the real economy in that the virtual resources simulate real items offered for sale by real merchants in the actual marketplace. The participants can engage in commercial transactions with respect to virtual resources, including purchasing, selling, or trading such resources. In another example, the virtual resources are virtual currency which can be used to purchase an item. To provide a challenge and add to the experience, in one detailed embodiment, the participants obtain virtual currency, or points which are spent as virtual currency, by accomplishing a specific task, such as playing a game or completing particular experiences.

In another embodiment, the present method for obtaining data enables the participants to create and control avatars to represent the participants in the simulated market economy. The avatars are displayed to other participants of the simulated market economy. For example, facial expressions, bodily movements, animations performed by the avatars, or clothing or accessories worn by the avatars can be changed by the participants. These expressions, movements, animations, clothing or accessories can be acquired by each participant in the simulated market economy and stored in the participant's inventory and later used to change the appearance or behavior of the avatar. When the appearance of the participant's avatar is changed, a signal indicating such change is transmitted from the client system used by the participant who has changed the appearance of such avatar to the client systems of the other participants through instant messaging. The client systems of the other participants then automatically contact the server system to find out what changes have been made and update the databases of these client systems and display the changed appearance of the avatar.

In another embodiment, the present method for obtaining data provides an incentive for a participant to recommend to other individuals to participate in the simulated market economy and enables the participant to send an installation file necessary to the individuals to participate in the simulated market economy. The incentive, for example, may be to award the participant who recommends that another individual participate in the simulated market economy by providing a new expression, movement, animation, clothing item or accessory to be stored in the participant's inventory and used by the participant at a later time to change the appearance or behavior of the participant's avatar.

In another aspect, the present invention features a method for obtaining data through the following steps. The method provides an on-line interactive community which simulates a market with multiple participants. In this community, at least two competing virtual merchants offer for sale competing virtual items. The participants are enabled to obtain one of the competing virtual items, thereby displaying a preference for the obtained virtual item. Data is gathered regarding which competing virtual items are selected by the participants.

In one embodiment, the method enables the participants to create and control avatars to represent the participants in this on-line interactive community. In another embodiment, the method enables the participants to acquire virtual items from the community, store such items in an inventory and later use them to change the appearance of their avatars.

In another aspect, the present invention features a method for obtaining data through the following steps. The method provides a simulated market with multiple participants. The method enables each participant to create an avatar to represent the participant in the market. The method further enables the participant to collect virtual resources used to control the appearance of the avatar. Upon a change in the appearance of the avatar of an individual participant, a signal is generated to reflect such change and transmitted to other participants through an instant messaging platform. This signal prompts a client terminal used by the other participants to automatically update and display the avatar with the change in the appearance. Data regarding the virtual resources collected by the participants is gathered.

In another aspect, the invention features a system for obtaining data. The system includes a module, an instant messaging platform, and a server. The module is configured to enable a first participant of multiple participants in a simulated market economy to obtain a virtual resource available from the simulated market economy. The instant messaging platform is configured to convey to a second participant a message which indicates that the first participant has obtained the virtual resource. The server is configured to gather data regarding a behavior of the first participant in the simulated market economy.

In one embodiment, the system includes a second module configured to enable the first participant to create and control an avatar to represent the first participant. For example, the first participant may be able to control a facial expression or bodily movement (animation) of the avatar or an item of clothing or accessory worn by the avatar. The system may further include a third module for storing virtual resources that are used to control the appearance of the avatar. In one detailed embodiment, the server may gather data regarding the virtual resources stored in the third module.

In one embodiment, the server is configured to gather data regarding usage of the virtual resources by the participants. In another embodiment, the server is configured to gather individualized data relating to preferences of the participants as displayed through the appearance of their avatars. In still another embodiment, the server is configured to gather aggregated data regarding the behavior of multiple participants in the simulated market economy.

In another aspect, the present invention features a system for obtaining data which includes a module and a server. The system provides an on-line interactive community which simulates a market. In this market, there are at least two competing virtual merchants who offer for sale competing virtual items. The module is configured to enable the participants to obtain one of the competing virtual items, thereby displaying a preference for the obtained virtual item. The server is configured to gather data regarding which competing virtual items have been obtained by the participants.

In one embodiment, the system further includes a second module configured to enable each participant to create an avatar to represent her and to control the appearance of the avatar. In one detailed embodiment, the system further includes a third module for storing at least one virtual resource which is used to control the appearance of the avatar.

In still another aspect, the present invention features a system for obtaining data which includes a first module, a second module, a third module, an instant messaging platform, and a server. The first module enables a participant to create an avatar to represent the participant in a simulated market. The second module enables the participant to collect virtual resources from the simulated market for use in controlling the appearance of her avatar. The third module generates a signal indicative of a change in the appearance of the avatar. The instant messaging platform is configured to transmit this signal to other participants in the simulated market, thereby prompting client terminals used by the other participants to automatically update and display the changed avatar. The server is configured to gather data regarding the virtual resources collected by the participant.

In one embodiment, the second module enables the participant to control a facial expression or a bodily movement of the avatar, or to change an item of clothing or accessory worn by the avatar. In another embodiment, the system includes a fourth module for storing the virtual resources used to control the appearance of the avatar.

In one embodiment, the server is configured to gather data regarding usage of the virtual resources by the participant. In another embodiment, the server is configured to gather data relating to preferences of the participant as displayed through an appearance of the avatar.

In yet another embodiment, the traditional computer role-playing games that rely on proprietary, end-to-end client server systems with a very large, full-screen client application (“fat client”) to deliver an immersive virtual community/role-playing entertainment application are combined with an instant messaging system employing a “thin client” standards-based client-server system to deliver an open-ended networked chat utility application. The result is a hybrid entertainment utility application that uses a mix of standards-based client-server protocols and proprietary 3D graphics.

### BRIEF DESCRIPTION OF THE DRAWINGS

Preferred embodiments of the present inventions taught herein are illustrated by way of example, and not by way of limitation, in the figures of the accompanying drawings, in which:

FIG. 1 is a diagram illustrating certain features of one embodiment of the system for collecting data;

FIG. 2 is a diagram of a distributed computer network;

FIG. 3 is a systems component diagram illustrating the interaction between the client and server side components of the present invention;

FIG. 4 is an exemplary screenshot of a user interface configured to support an instant messaging communication format, the role-playing game and the customizable avatar;

FIG. 5 is an exemplary screenshot of the “Me” panel;

FIG. 6 is an exemplary screenshot of the Worldview panel;

FIG. 7 is an exemplary screenshot of the station panel;

FIG. 8 is an exemplary screenshot of the IM panel;

FIG. 9 is an exemplary screenshot of the Multi-party IM panel;

FIG. 10 is a flow chart illustrating a process for synchronizing a client's local cache with the network's shared database;

FIG. 11 is a diagram illustrating communication between network devices configured to implement a virtual gaming environment of the present invention;

FIG. 12 is an exemplary illustration of a model diagrammed using geometric data;

FIG. 13 is an exemplary illustration of slicers positioned around points of a shirt;

FIGS. 14a and 14b are graphical illustrations of a nude avatar model bisected by slicers;

FIGS. 15a, 15b and 15c are graphical illustrations of a shirt model and the avatar model being rendered together thus depicting the avatar wearing the selected shirt; and

FIG. 16 is a flow diagram of the graphics process having both infrequent data preparation processes and frequent data preparation processes.

### DETAILED DESCRIPTION OF THE PREFERRED EMBODIMENTS

A. Overview of Method and System for Obtaining Data

In one aspect, the present invention relates to a method and system for obtaining data. In general, the method and system are based on creating a simulated market economy with multiple participants and gathering data regarding the behavior of individual participants in the simulated market economy as they engage in virtual commercial transactions. A simulated or virtual market is a decentralized virtual environment in which any two participants can engage in the buying, selling and trading of virtual resources. In this context, a virtual resource may comprise any item that can be obtained in the virtual market or exchanged between participants in the virtual market, for example, a virtual good such as an item of clothing for an avatar, or an object representing an animated movement that can be used by the participant to animate an avatar, for example a smile, or an object of virtual currency, for example points that can be exchanged in the virtual market for other virtual resources. Furthermore, the term participant is used herein to describe an individual participating in the simulated market, or a system user and is synonymous with user, player, individual and role-playing participant.

For example, the simulated market economy may be created through an on-line, interactive community. The participants may be able to engage in commercial transactions such as purchasing, selling, trading or sharing virtual items or resources. The system can track and mine data regarding the participants' behavior in this market and generate valuable market research information which can be sold to and applied by real-world marketers as a proxy for real-world market research.

This method and system for obtaining data can be customized for different demographic groups. For example, it can be customized to appeal to and target “tween” and teen girls. It is believed that “tween” and teen girls are replacing face-to-face and telephone conversations with email and instant messaging. This group averages one to three hours per day using instant messaging and typically have in excess of one hundred friends on their buddy lists. Studies have shown that interruptive messages such as pop up ads or on-line commercials are less effective in reaching “tween” and teen girls.

In one embodiment of the present invention, the system and method for obtaining data uses this powerful instant messaging platform. Specifically, the system described herein provides an interactive, on-line community which simulates a market that preferably appeals to the “tween” and teen girls. It is understood that the invention contemplates providing a virtual market which may target demographic groups other than “tweens” and teen girls, such as teen boys, college students, NASCAR fans, or housewives. In the examples provided below, “Tween” and teen girls would participate in this simulated market by engaging in simulated commercial transactions such as buying, selling, and trading certain items such as clothing and their behavior in this market would be tracked, mined, and studied to be applied to the real market. To encourage “tween” and teen girls to participate in this simulated market, the present system uses the following features:

First, the interactive, on-line community which simulates a market is created within a role playing game environment which is appealing to the target demographic group. Specifically, each participant has the ability to create and customize an avatar which represents the participant, thereby allowing such participant to express her individualism in this environment. It is important to note that the term avatar is synonymous with character or virtual character used herein and is a graphic object which represents a participant in the simulated market or system.

For example, the system may enable the participant to create a three-dimensional avatar, assign a personality to the avatar, create and change the expressions of the avatar, control the movement or animation of the avatar, and dress and accessorize the avatar. The participant's avatar, including any changes in the appearance of the avatar would be displayed to other participants in this community. Through the avatar, the participant can engage in social interactions with other participants in the simulated market.

Second, the present system and method enable participants to engage in social behaviors in which they have a strong interest. For example, studies have shown that “tween” and teen girls have a strong interest in features such as shopping, collecting, trading, and socializing. The present system and method simulates a real market by creating a virtual market, in which the participants can shop, purchase, sell, trade, collect, and share virtual items or virtual resources that are acquired from the virtual market, and use those items (e.g., accessories and clothing) to customize their avatars. The virtual items may simulate real items offered for sale in real stores. The system and method also permits participants to collect points or currency to use to purchase the virtual items.

Third, the instant messaging platform provides the underlying communication platform for the present system and method. The instant messaging platform enables (i) communication between the participants while they are participating in this virtual market and (ii) communication between the client systems used by the participants to access the virtual market and the server system supporting the present system of obtaining data as further described herein. For example, using instant messaging signals as described herein, the participants may engage in a transaction involving borrowing, trading, or sharing a virtual item with the other participants. In another example, the instant messaging platform can be the mechanism by which an appearance or any change in the appearance of one participant's avatar can be conveyed to other participants. For example, when a participant obtains any virtual item for its avatar, a signal may be generated to indicate this fact and the signal may be automatically transmitted to the client systems of the other participants. The transmitted signal would prompt the client systems to contact the server system to find out what item has been acquired and update their respective databases based on this information. In addition, if an appearance of the avatar is changed, for example, if the avatar is wearing a new article of clothing, a signal may be generated to indicate this fact and the signal may be automatically transmitted to the client systems of the other participants. The transmitted signal would prompt the client systems of the other participants to look up the display information for the new article of clothing in the local client database. The local client would then display the new article of clothing on the avatar representing the participant whose client system transmitted the signal. This feature is described in greater detail herein.

The present system can track data regarding the individual participant's behavior in the simulated market as well as aggregated data regarding multiple participant behavior in the market. This may be accomplished through a server. Examples of aggregated data that may be tracked include: (i) data concerning the number of participants who have visited a particular virtual store; (ii) the number of participants who have selected a particular virtual item to be worn by their avatar; (iii) the number of participants who have used virtual currency to purchase a particular virtual article of clothing; (iv) how much virtual currency was spent on average to purchase a particular virtual item during a particular period of time; (v) overall trends relating to such virtual pricing over time; (vi) the relative popularity of individual items or particular brands who are represented in the virtual market economy; (vii) how many participants have traded a particular item with another participant; and (viii) data concerning which virtual stores or clothing items are the most popular among participants in general, or among participants in a particular demographic grouping, such as age, race or zip code. In addition, the system may track data regarding the individual participant's purchasing behavior, preferences for certain items, or trading behavior by tracking the virtual items stored in an inventory designated for such participant and/or based on the appearance of the participant's avatar which is controlled by the participant. The tracked data may be mined and studied to generate certain market research studies. This data can be particularly useful to retailers, manufacturers and other consumer marketing companies in evaluating the potential success of their real products in the real market among a particular demographic group.

Provided herein is a brief summary of the features of one embodiment of the present system and method for obtaining data.

B. Role-Playing Game Goals

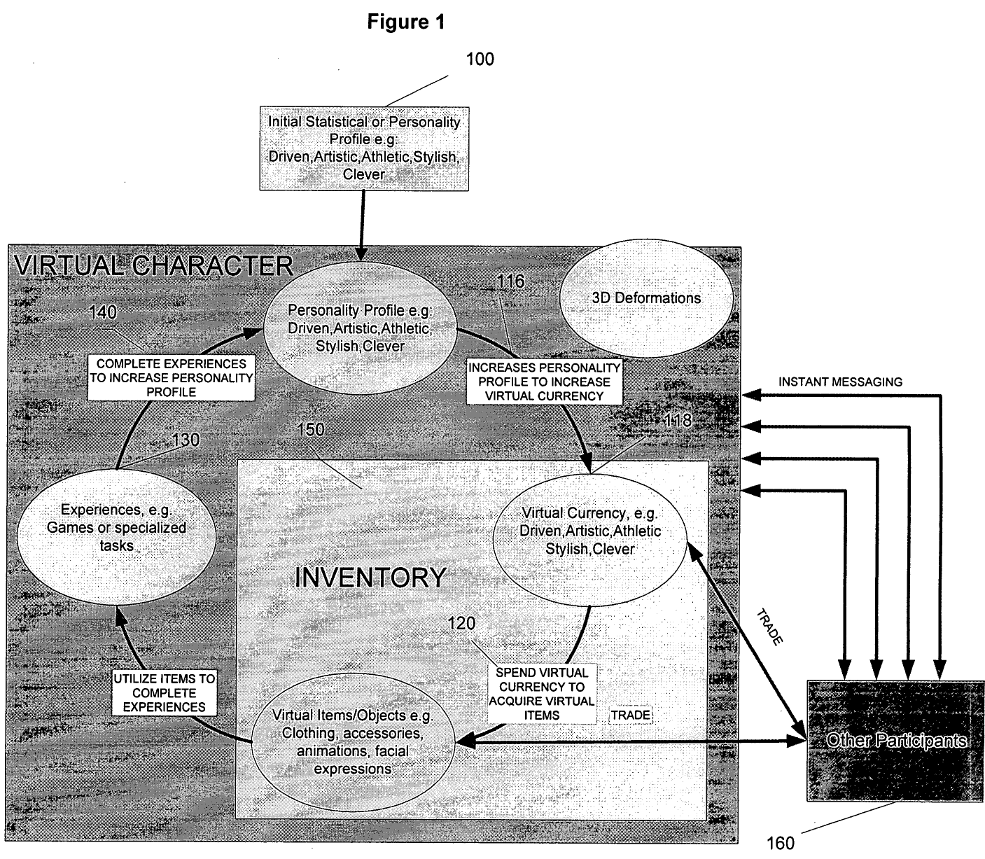

As discussed above in general, in one embodiment, the present system for obtaining data is an engaging system that includes self-expression, trading and socializing, which enhances the overall experience of instant messaging and avatar building. The system is not a “game” per se, in that there may not be any strictly competitive goals. However, the activities of earning, trading and collecting in this setting have a game-like aspect and the overall system may be referred to as a “game” hereon. FIG. 1 illustrates certain features of the present system.

The participants of the game may create their own goals, some of which might include:
1. Collecting the largest quantity of clothes, accessories and items to dress up and animate the avatar;
2. Creating the most distinctive outfits by mixing and matching the virtual items;
3. Building up the most distinctive personality by completing multiple games or tasks linked to a particular category of personality points, as described herein;
4. Being the richest player in amassing virtual currency;
5. Building the best reputation among a group of participants by generously lending out accumulated items to other participants;
6. Knowing the most people by creating a large instant messaging buddy list;
7. Winning contests for virtual or offline prizes

1. Personality Profile

When the participants first join the on-line, interactive community, the participants may be asked to create a three-dimensional avatar to, for example, represent an individual participant or other visual representation. For example, the participants may customize physical attributes of their avatars such as hair color, skin color, facial features, body shape and style. The mechanism by which an avatar is created is described in detail herein. As explained herein and shown in FIG. 1, an avatar is associated with a number of data items. These data items include, but are not limited to, personality profiles, inventory items, experiences and virtual currency.

The participants may create a statistical or personality profile for the avatars, consisting of numerical values assigned to each of several personality categories as shown in step 100. This personality profile would determine the amount and type of bank points that the participants would receive to spend in virtual stores, and would affect the game play on a continual basis. The bank points would act as virtual currency.

For example, the personality profile may be generated by assigning numerical levels in each of the following personality categories, or other categories:
Driven
Artistic
Athletic
Stylish
Clever

All participants may start with a certain number of levels in each personality category for parity. A participant would then choose how to distribute additional levels provided. However, the distribution of these levels may determine the amount and type of bank points or virtual currency the participant would have to spend in the virtual stores, and therefore what types of clothing, accessories, experiences and other objects could be purchased. Bank points would be used as money in the virtual market economy. Participant would have an incentive to increase personality profile to increase the virtual currency as shown in step 160. The participant could spend them in the virtual store as shown in step 120 or trade them with other participants as shown in step 130. The types of bank points required to buy an item depend on what type of item it was. Purchasing exercise clothing or equipment, for example, would require Athletic points, while purchasing books or music would require Artistic points.

Here is a specific example of a personality profile created for an avatar:

| Category | Level |
|---|---|
| Driven | 4 |
| Artistic | 4 |
| Athletic | 3 |
| Stylish | 2 |
| Clever | 2 |

Thus, in the example above, the participant's avatar would have level 4 Driven, level 4 Artistic, level 3 Athletic, level 2 Stylish, and level 2 Clever. Specific details relating to creation of a personality for an avatar are further discussed in detail herein.

2. Bank Account

In the on-line, interactive community, each participant would have a bank account in which she would accumulate a certain number of bank points. As described above, the participant would initially receive a certain number of bank points for each level in the initial personality profile that the participant has created for her avatar.

The bank points may be used as virtual currency to participate in the simulated market. For example, the bank points may be used to purchase virtual items or resources from the virtual stores in the simulated market, traded with other participants, “invested” in a savings account to accrue interest, or traded to the bank at a fixed ratio for points of another category.

3. Earning Bank Points

Each participant may be able to obtain the desired types of bank points in various ways. In one detailed embodiment, the participant may be allocated a certain number and type of bank points each day. For example, every day at 7AM EST, three out of the five point categories may be allocated randomly and every participant may receive a certain amount of points in these categories. Therefore, on the first day of participation in the simulated market, for example, the participant may receive two bank points for each of the levels in her personality profile. Thereafter, for example, she may receive one bank point for each level she has in a selected personality category.

To encourage the participants to play the game every day, for example, the participants may be allocated bank points only if they sign in to the system on that day and they would earn bank points only once a day (i.e., signing on and off multiple times on the same day would not result in earning additional bank points).

Alternatively, the participants may be able to earn additional levels for their personality profile by completing a particular game, task, or experience as shown in step 140. An example of such a game, task, or experience would be a requirement that a participant collect, either by purchasing for points or by trading with other participants, a certain quantity and type of virtual items. After acquiring the required virtual items, the participant's personality profile would increase by a given number of levels in a particular category; alternatively, the participant would be given the opportunity to allocate an additional number of levels among the categories in her personality profile, thereby increasing the number of future bank points earned in those categories to which she assigned the additional levels. This will provide participants with a sense of accomplishment at having built up their personality profiles over time and having increased their bank point earning capacity and their ability to acquire new and more costly items for their avatars, and generally enhance their experience with the overall system and their status within the community of on-line participants.

4. Purchasing Items

Referring to FIG. 1, the virtual stores may be the primary place the participants spend their personality points to purchase virtual items for their avatars as shown in step 120. These stores are represented by graphical displays that are accessed by clicking on clearly labeled tabs within the system interface. The prices of the virtual items may reflect their value in the real market. For example, some items such as a simple shirt from a casual clothing store may be quite affordable and require few bank points to acquire, whereas a fancy blouse from a designer brand may be quite expensive, and thus require more bank points to acquire.

In addition, the participants would need the right type of bank points to buy an item. For example, a casual shirt may cost three athletic points, while a fancy blouse may cost forty stylish points.

In one embodiment, the virtual stores may be organized into different sections to promote certain items as is commonly done in real stores. For example, a store might have a section for “new items” and/or a section for “sale items.” In addition, the virtual store may have different sections for different types of items.

When the participant purchases a virtual item, the amount of points shown as the price of the virtual item would be removed from her bank account and the item would be moved into her inventory.

In one embodiment, the system of the present invention includes multiple stores which offer for sale competing goods of the same type. In this manner, a participant's preference of one brand or style of item over another competing, similar item can be determined based on the item selected or otherwise acquired by the participant.

Alternatively, the participants may trade virtual items with one another or loan or borrow a virtual item from one another as described herein.

5. Selling Items

As discussed above, one way for a participant to generate more currency may be to sell virtual items previously purchased back to the virtual stores. The sell back price of an item would be determined by its state of decay (see below) and its original value. All items will decay over time—more so if they are used or worn. For example, the following variables may be used to determine the depreciated value:
Lifetime type (instances or wear & tear)
Lifetime total (count of instances or system hours)
Usage rate
If instances=how many per use
If wear & tear=percentage per hour of use

Items that age by wear and tear that are left in the inventory would not age. If they are worn by either the participant's avatar or a friend's avatar, however, they would age.

In another embodiment, in the inventory mode, the participant may able to repair an item that is worn out. As with sellback price, the cost to repair an item would be a function of its current state of decay and its original price.

6. Trading Bank Points

If a participant wants to buy an item but does not have the right type of bank points to buy such item, she may be able to trade some of her bank points in one category with another participant who has the right type of bank points as shown in step 130. This feature encourages trading behavior among the participants. For example, if a participant has a lot of athletic points, but she really wants to buy a silk blouse, which requires more stylish points, she can trade some of her athletic points with another participant 60 for stylish points.

If a participant cannot find another participant with which to trade bank points, she can trade with the bank at a fixed exchange rate. For example, the exchange rate may be one of any category of bank points for every three points of any other category of bank points surrendered to the bank.

7. Inventory

Referring to FIG. 1, based on the personality profile of the avatar created by the participant, each avatar may start out with a basic inventory 150 of virtual clothing items such as a t-shirt, pants and/or skirt, as discussed above. These items may be enough to dress an avatar initially, but the participant would have an immediate incentive to visit the virtual stores to augment the inventory in pursuit of increased status among the community of on-line participants. This is one way to encourage the participants to actively participate in the simulated market.

The inventory 150 of virtual items for the avatar may be organized into a number of sections. For example, the various sections may be clothing, accessories, expressions, animations, or other sections. The clothing section may include shirts, blouses, pants, skirts, dresses, and other clothing items. The accessories section may include hats, bags, shoes, jewelry, hairstyles, make up, shawls, scarves, or other items used to accessorize an avatar. Expressions and animations sections are described in greater detail herein. Although the inventory 150 would primarily consist of virtual items acquired for the participant's avatar, the special section may also include real items purchased using virtual bank points for the participant's own use, such as mp3 files, coupons, certificates, and other supported items.

8. Expressions and Animations

In one embodiment of the present invention, the participants can acquire not only virtual items but can also acquire animations and expressions for their avatars and store them in inventory 150. Although acquiring animations or expressions for the participants' avatars may not have a direct impact on a market research study, they enhance the participants' experience in the on-line, interactive community and thereby encourage them to spend more time participating in the community.

“Animations” are bodily movements for an avatar such as strut, shimmy, leap, fall down, leave, be right back, kick, groove and other animations.

“Expressions” are facial gestures that an avatar can make while a participant is interacting with other participants. For example, each participant may start out with several basic expressions, such as “smile” or “frown,” but subsequently be provided with an opportunity to acquire more complex expressions, such as sneer, angry, shrug, sad, surprised, scared, wink, blink, stare or other expressions

9. Experiences

Referring to FIG. 1, step 130, “Experiences” are games or tasks that the participant can complete in order to receive a reward comprising enhancements to the participant's avatar, inventory or status within the online community. For example, an experience may require that the participant acquire certain prerequisite items to complete the experience, but upon completion of the experience, the participant may be rewarded with additional levels for her personality profile as shown in step 140. To provide the participant in the on-line community with a more interesting and interactive experience, in one embodiment, some of the items required for completing an experience may not be available in a virtual store. For example, some rare items may be propagated directly to random participants, creating a situation where the participants will be forced to trade or cooperate with each other to complete experiences requiring these items. This will create a complex interactive dynamic among the participants.

As described above, the basic activity of completing an experience involves acquiring a specified set of prerequisite objects, either on the participant's own, or in cooperation with other participants. These objects may be acquired by buying them from the store, by completing other experiences, by trading items with other participants, or as bonus items propagated to certain participants by the system. For example, if the experience is a “Trip to Paris,” then the participant may be required to obtain the following prerequisite objects: passport, French class, and walking shoes.

In this example, walking shoes and a passport might be available from a virtual store, but French Class is a rare item that the system may have provided as a bonus item only to selected participants. In order to complete this experience, the participant will need to find someone else who has access to French Class and either invite her to help complete the experience together, or trade for that item.

To further encourage interactions among the participants, some experiences may require multiple participants to work together to acquire the prerequisite items in groups, while other experiences may require a single participant to buy, receive, or trade the required items. For example, in order to form a cheerleading squad, a minimum of five participants would be required to each acquire a cheerleading skirt, a varsity sweater, a set of pom-poms and five separate cheerleading animations.

10. Balancing the Economy

In one embodiment, the overall economy of the simulated market includes the concept of supply. All items would be released into the market in defined amounts, which in general would be in a fixed proportion to total membership or usage by the participants. Items considered “special” would be released in a smaller proportions than items that are staple items. This would further encourage trading of special items between the participants and create a market pricing mechanism for trading among participants.

11. Recommendation to Others

As a further incentive for a participant in the on-line community to recommend to other prospective participants to join the community, the present invention provides a method whereby an existing participant can send an installation program to a prospective participant, for example by e-mail attachment or as an instant messaging file transfer. The system will grant a reward to the participant for inviting a prospective participant, such as a virtual item of clothing or an animation or other incentive. The system would differentiate between an invitation to a prospective participant which is merely received by the prospective participant, and an invitation which is actually accepted by the prospective participant, resulting in that prospective participant's downloading and installing the installation program and becoming an active participant in the on-line community. The virtual reward for merely sending an invitation to a prospective participant would be less valuable in terms of its degree of scarcity in the virtual economy or its price in the virtual store. For example, the reward may be a plain black t-shirt. The virtual reward for an accepted invitation resulting in a completed installation of the software would be commensurately more valuable. For example, the reward may be a set of five animations available exclusively to those existing participants who have successfully invited five new participants to participate in the online community. The system would allow the ability to collect and track data regarding which participants are the most active and successful in recruiting new participants to the online community.

C. System Architecture

1. System Overview

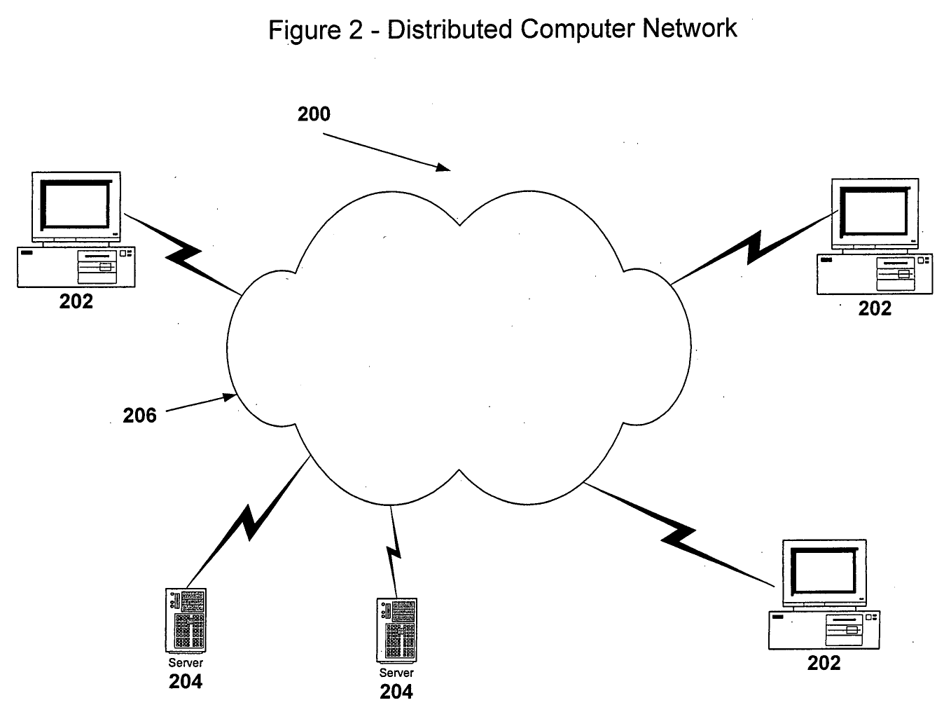

FIG. 2 is a diagram of a distributed network environment over which a system, having a differentiated instant messaging environment, may be deployed. As illustrated, the distributed network environment 200 comprises multiple clients 202 and servers 204 connected together by a communications network 206, such as the internet, or other communication network. The distributed environment 200 may comprise numerous Web-based technologies which allow the system to realize the benefits of distributed computing. For example, TCP/IP provides a network-independent transport layer while web clients 202 and servers 204 eliminate operating system dependencies. Furthermore, software components such as extended markup language (XML) enable data to be shared independent of software. As the virtual gaming system is explained in more detail herein, it is important to note that any architecture and software technology may be coupled together to construct this system. Thus, the system architecture set forth herein is exemplary and should not be construed as limiting.

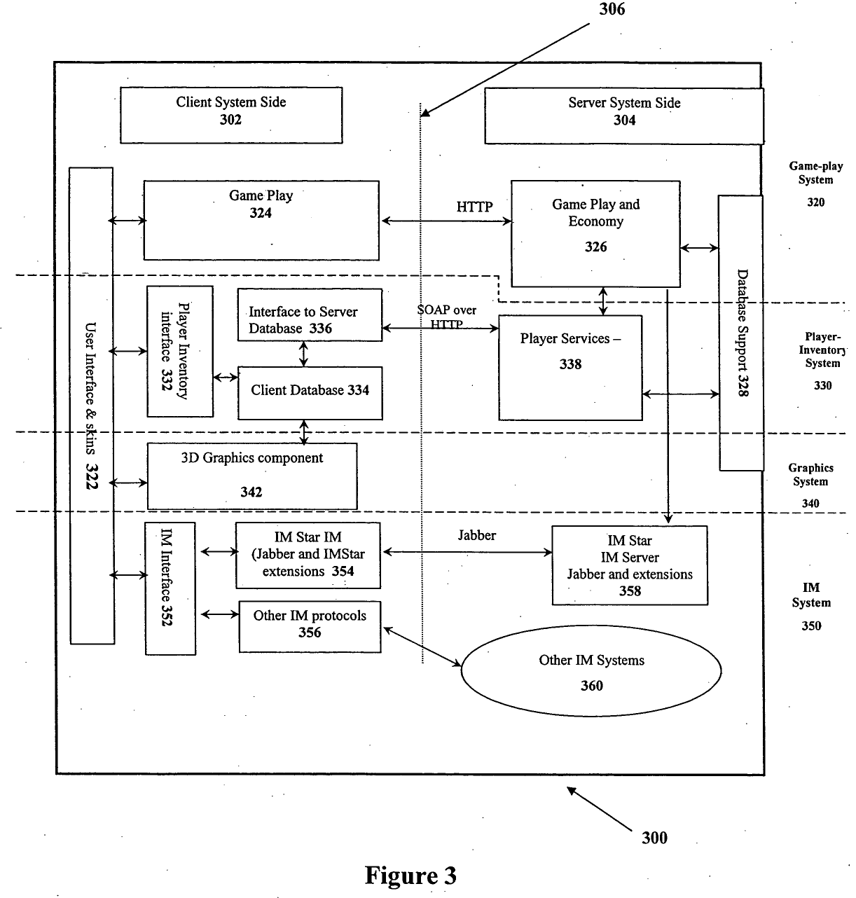

FIG. 3 is an architectural diagram depicting an exemplary embodiment of a virtual gaming environment system 300 configured in accordance with the systems and methods described herein. More specifically, FIG. 3 is a diagram illustrating a system configured to incorporate an instant messaging (“IM”) system with a role-playing game. As illustrated, the virtual gaming environment system 300 includes a client computer/system side 302 and a server computer/system side 304. The client side 302 may communicate with the server side 304 using a TCP/IP connection over communications network 306.

To more efficiently describe the interaction between the client side components and server side components set forth above, the virtual gaming system 300 can be divided into four sub-systems including: a game-play sub-system 320, a player inventory sub-system 330, a graphics sub-system 340 and an instant messaging sub-system 350.

A client application operates on each client side computer 302. On the front end, a graphical user interface component 322 allows a user to interact with the client application. On the back end, the client application interacts with specific components of the present invention that enable the virtual gaming environment to be implemented over IM. Numerous IM protocols may be used to provide a communication foundation including, but are not limited to, SIP/SIMPLE, XMPP and OSCAR. Specifically, the client application includes a game-play component 324, a player inventory interface 332, a 3D graphics component 342 and an IM component 254. These components may be implemented in software, hardware or any such combination. Each of the client side components will be described herein in further detail.

Like the client side of system 300, a server application operates on the server computer 304. The server application includes several components that may be implemented in software, hardware or any such combination. These components include a server side game-play component 326, a player service component 338 and an IM server 358. As illustrated, the game-play component 226 and the player services component 338 each interact with a shared database 328 as explained herein in more detail.

a.) Game-Play Sub-System

As explained above, the present invention provides a virtual gaming environment implemented using an instant messaging (IM) communication platform. In general, a gaming module manages the virtual gaming environment described herein. The interaction between the game-play components on the client and server side are illustrated in FIG. 3.

As shown, FIG. 3 depicts the client side game-play component 324 coupled to the user interface 322. From the user interface 322, a user may select certain actions, such as experiences, trade items, shop, communicate, or other such actions. The game-play component 324 receives the selected signals from the user interface 322 and communicates with the server side game-play component 326 over network 306 using the hypertext markup language protocol (HTML) over hyper-text transfer protocol (HTTP). As such, HTML is used for browser display purposes while HTTP is a top level communication protocol used to request and post data. Other protocols, however, may be used for communication purposes between the client side game-play component 324 and the server side game-play component 326.

More specifically, the client side game play component 324 employs an embedded web browser and provides interface routines for integration with the user interface component 322. The browser uses HTTP to interact with the server game play module 326 which may be a J2EE web application server. The game play module 326 implements the game rules and returns data to the browser for display. As explained above, the game consists of shopping and performing other transactions in a virtual store, playing experiences, trading items and points, lending items and displaying levels and points. When a participant specifies at least one of these actions, HTTP commands are sent by the game play component 324 to the server game play component 326. Specifically, the selected actions are encoded in the URL sent to the server game play component 326 via the HTTP commands.

The server game play module 326 carries out the transactions updates the shared database 328 by changing the appropriate store and player records. The game-play server component 326 may send a message via the IM server component 358 to the client. For example, if the transaction carried out by game play server component 326 is a purchase transaction, a message is sent to the client to cause the client to update the player's inventory. Specifically, the client IM module 354 receives the message, decodes it as a system message and then passes it to the user interface module 322 via the IM interface module 352. The user interface module 322 requests the player inventory system 330 to update the local client database 334. It is important to note that requests from the client application are made using HTTP or SOAP over HTTP while server side requests are made via instant messaging.

b. Player Inventory Sub-System

The player inventory sub-system 330 provides local and remote access to a role-playing participant's inventory. The player inventory is a view of data that is stored in the shared database 328 for each player. The player inventory system 330 provides rapid access to this stored data for the client side system 302. In one embodiment, data stored for each participant may include a player inventory and a player properties. Data stored in the player inventory may include, but is not limited to, the basic nude model, including morph targets for facial deformations; information for body deformations; basic texture map for the body; clothing models including texture maps for the clothing; body animation files; facial animation files; game items used to play experiences; experience information; player's bank points and each player's levels. Player property data is also stored and includes deformation information regarding a participant's avatar; color information for a participants avatar (i.e.: which tells the system how the base texture map should be altered to reflect the participant's color choices); wear orders which indicates what clothes the participants avatar is wearing and timestamp data for synchronization purposes.

The player inventory sub-system 330 consists of three components on the client side, namely a player inventory interface component 332, a client cache database 334, and a server database interface 336. The player inventory sub-system 330 is responsible for providing rapid consistent access to the participant's own player inventory and the player inventories of the participants' respective buddies. The player inventory interface component 332 receives requests for player inventory data from the user interface component 322. These requests are turned into database queries by the player inventory interface component 332 and are passed to the client database 334. The client database 334 is a cache for the player inventory data stored in the server side database 328. If the client database contains the information requested in the query it returns it to the player inventory interface component 332 as requested. If, however, the client database 234 does not contain the data, the user interface instructs the server database component 336 to fetch the item from the shared database 328. Optimally, the player inventory sub-system 330 keeps as much information locally on a participant and her buddies as possible while maintaining synchronization with the shared database 328.

On the server side, a player services component 338 implements a view of the shared database 328 suitable for the client application. The player services component 338 authenticates all requests by the client application and ensures that updates and insertions preserve data integrity. The server database interface component 336 communicates with the player services component 338 by making remote procedure calls using the simple object access protocol (SOAP) transported over HTTP, thereby supporting the client applications queries and operations. It is important to note that communication between the server database interface 336 and the server side of sub-system 330 may use other protocols such XML.

As will be explained in more detail herein, the synchronization between the client cache database 334 and the shared database 328 is minimized by marking certain database records with a modification timestamp. When synchronization is required, the client side interface 336 requests only those records having timestamps later than its most recent synchronization for the player in question.

The user interface module 322 is largely unaware of the nature of the client database, i.e., the query language or the means of synchronization with the server. The user interface module 322 accesses data in the player inventory system and occasionally requests that a player's data and inventory be synchronized with the server when it receives a message from the server via instant messaging. The application can access and query the client database regardless of whether there is an internet connection to the server.

c. Graphics Sub-System

As explained herein, players may customize their avatar, for example, by shaping or deforming their avatar, dressing their avatar or providing their avatar with animations. A character module, and more specifically the graphics sub-system 340, is dedicated to performing these tasks. As illustrated in FIG. 3, the client side of sub-system 340 comprises a 3D avatar component 342. The 3D avatar component 342 addresses several significant problems associated with displaying 3D objects using current high-end graphics cards. For example, polygon counts must be kept to a minimum for both optimized rendering and animation processing. In addition, since the system 300 uniquely allows users to place clothing on the avatar and further allows clothing to be layered, the 3D objects (body and clothing) must be layered to avoid a first image from visibly bleeding through when a subsequent image is placed over the first image. Since the system also allows the single avatar to be customized with deformations, the clothing must be similarly deformed. After reshaping the avatar and adding clothing the animations must still be applied and look real. The graphics subsystem 340, and more particularly the 3D avatar component 342, use a unique 3D graphics process to achieve this level of customization. A detailed description of the 3D graphics process of sub-system 340 is provided herein.

d. IM Sub-System

Instant messaging is used as the channel of communication between the server system side 304 and the client system side 302. As described herein, the system 300 allows role-playing game participants to communicate using an instant messaging platform. Specifically, a participant selects, from a predefined list, another role-playing participant with whom they wish to communicate. As such, the IM platform combines the features of IM including buddy lists, presence notification, multiparty IM, with a virtual gaming environment.

Instant messaging is also the communication platform for interacting with other participants, for example, by sharing, trading and purchasing of objects among the participants. In other words, instant messaging is used to indicate when a first user changes parameters of their avatar so the same changes can be made on the computer screen of a second user who is in communication with the first user. In short, instant messaging therefore provides the underlying communication platform for the entire system 300.

To enable the interactions described herein, the IM sub-system 350 comprises components on both the client 302 and server 304 system side of system 300. As illustrated in FIG. 3, the client side components of the IM sub-system 350 include an IM interface component 352, a Jabber extension component 354 and a protocol component 356. Specifically, the IM interface component 352 hides the details of the particular IM system from the user interface 322. The IM interface component 352 also provides access to functionalities such as buddy list manipulation, presence notification and subscription management, establishment and management of one-on-one dialogs, and establishment and management of many-to-many conversations or conferences, transmission and receipt of system-level communications. Importantly, the IM interface component 352 also transmits and receives notification that a participant's records have changed and thus require resynchronization. The IM sub-system 350 is implemented using the Jabber (XMPP) protocols and a standard Jabber server 358 as depicted on the server side of system 300. It is important to note that the IM interface component 352 allows the user interface 322 access to other IM protocols implemented in component 356 and through those protocols provides access to IM systems such as AIM and Microsoft. Other IM protocols may also be used to implement the invention in place of the Jabber (XMPP) protocols. A detailed example of how this differentiated IM environment works is provided herein.

2. The User Interface

a. Overview

The user interface 322 acts as an interface between the user and the system components. More specifically, the user interface 322 presents and receives information from the user and acts as a unifying element among the client side components. The user interface component 322 interacts with a number of system components including the game-play sub-system 320, player inventory sub-system 330, the graphics sub-system 340 and the IM sub-system 350.

In addition to presenting and receiving information from the user, the user interface incorporates other functionalities. As illustrated herein, the user interface may be divided into a number of panels, each of which communicate with the various sub-systems described herein. For example, when two players trade items, the user interface corresponds with the player inventory sub-system, and more specifically the player inventory interface, to present inventory contents available to each player. Furthermore, the user interface communicates with the game-play sub-system to affect a trade and with the IM sub-system which provides communication between the participants and between the server and client software.

b. Skins

The user interface may be customized by the user. For example, the user may select different skins for the interface. A skin is a customized graphic used to replace a computer application's default interface. Changing the skins of the user interface changes its look and feel as desired by the role-playing participant. One can vary the artwork, the position of buttons, sliders and other controls, and the layout of the panels.

c. Panels

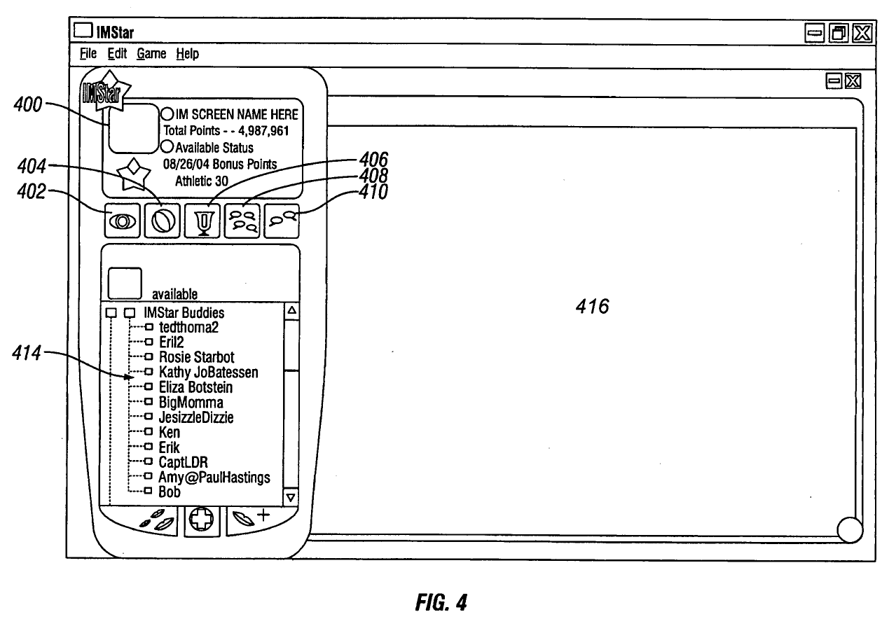

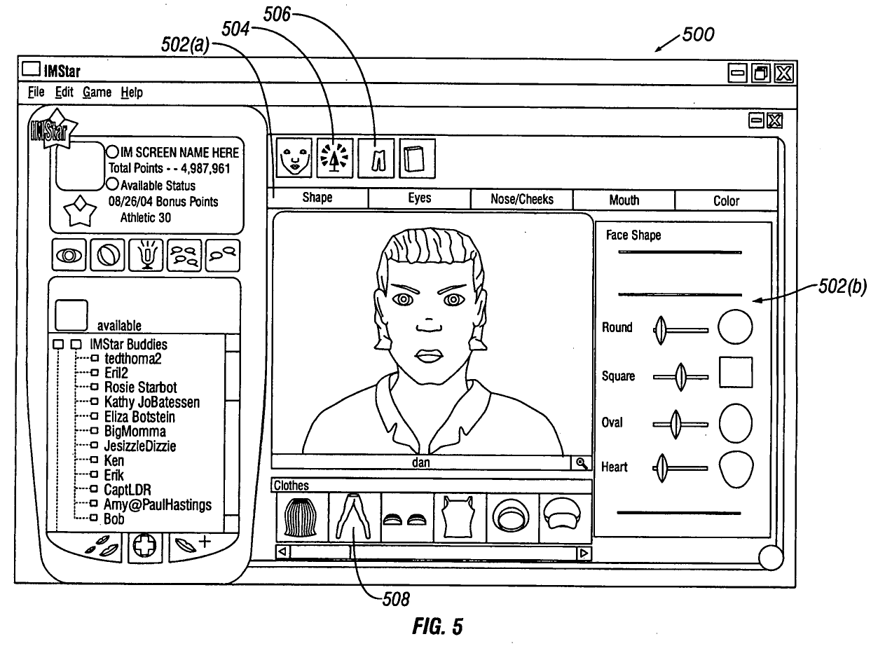

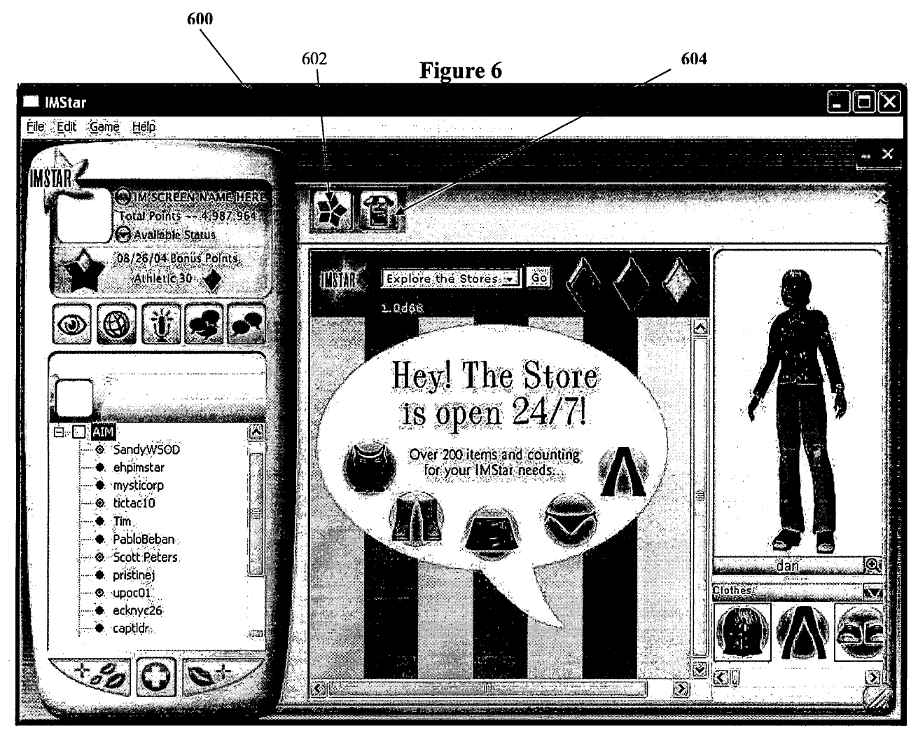

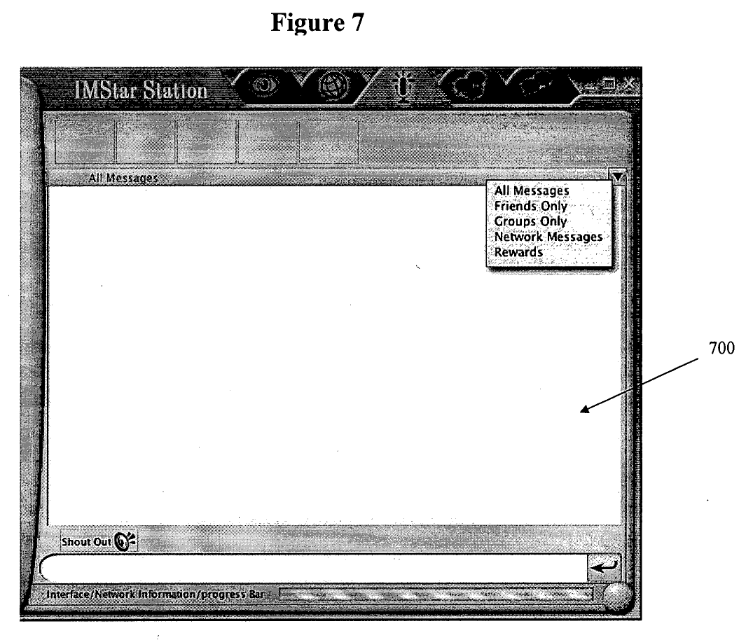

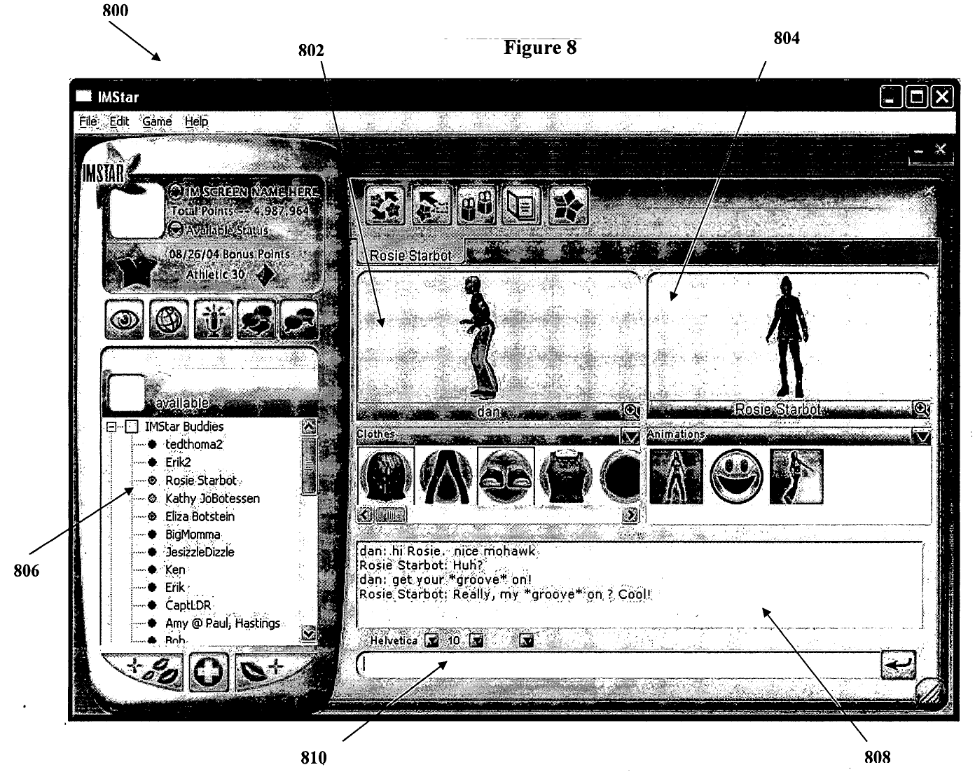

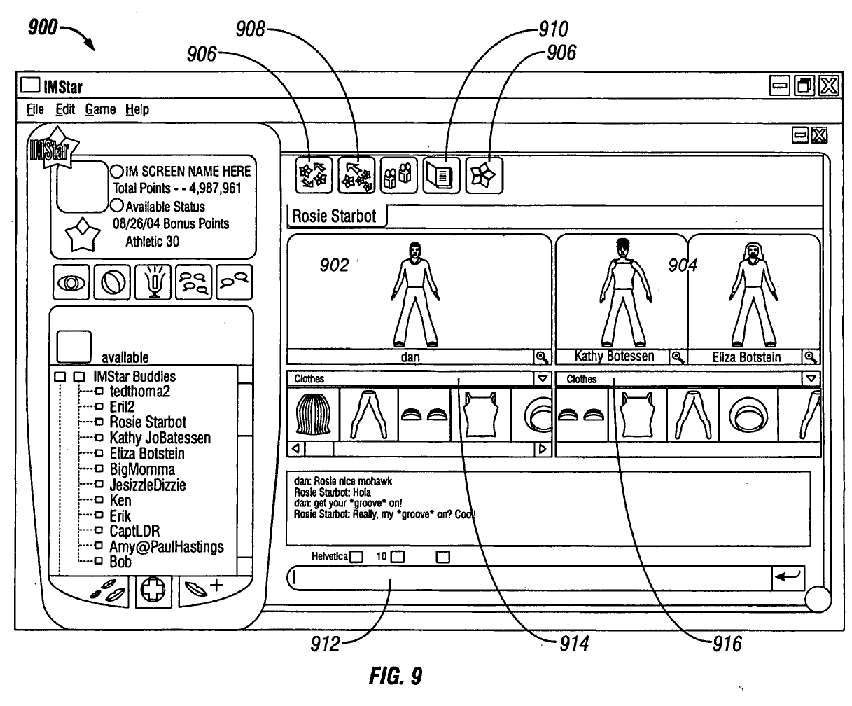

FIG. 4 is an exemplary screenshot of a user interface configured to support an instant messaging communication format, the role-playing game and the customizable avatar. Numerous user interface panels may be used to allow the participant to interact with the virtual gaming system of the present invention, thus FIGS. 4-9 and their respective descriptions should not be construed as limiting. These exemplary panels may include a central panel 400, a “Me” panel (FIG. 5), a worldview panel (FIG. 6), a station panel (FIG. 7), an IM panel (FIG. 8) and a multiparty IM panel (FIG. 9). Obviously, the user interface may comprise any number of panels addressing a plethora of purposes.

i The Central Panel

The central panel 400 is the main panel from which other top level panels may emerge. From the central panel, a participant may access other panels by selecting the appropriate icons. These icons include, but are not limited to the “me” panel icon 402, the worldview panel icon 404, the station panel icon 406, the multi-party IM panel icon 408 and the IM panel icon 410. When any of the above icons are selected, the corresponding panel opens in section 416. The central panel 400 also displays a participant's buddy list 414, the status of each buddy, a summary of a participant's bank points and other personal data. A participant may also manipulate their buddy list, change their status, start IM conversations and multiparty chats and perform other standard IM activities from the central panel 400.

ii. The “Me” Panel

FIG. 5 is an exemplary screenshot of the “Me” panel. The Me panel 500 allows a participant to customize their virtual character. The panel 500 provides the player with customization icons including: an avatar facial customization icon 502a/502b (i.e.: shape, eyes, nose, cheeks, mouth and color); an avatar body customization icon 504 (i.e.: shoulders, bust, arms, waist, legs, hips), and an access bank account icon 506 that allows the participants to see their current level and bank points. Furthermore, the Me panel 500 allows players to change their avatar's clothes using icons 508.

iii. The Worldview Panel

FIG. 6 is an exemplary screenshot of the Worldview panel. From the worldview panel the participant may perform various actions by selecting the appropriate icons. These actions include, but are not limited to, playing experiences 602, shopping 604, accessing their inventory and changing the avatar's clothes. Selecting the experience icon 602 lets the player look at the available experiences for play, access the experiences that the player is currently in the process of completing and join experiences with other participants. Selecting the store icon 604 lets the participant shop in the virtual store and purchase clothing, hair, facial and body animations, game items needed to complete an experience and other avatar accessories.

iv. The Station Panel

FIG. 7 is an exemplary screenshot of the station panel. The station panel 700 receives various shout-out messages, sent by a player to a group of buddies at one, in addition to system messages. For example, station panel 700 may receive system message informing the player of a special item for sale or the receipt of a reward for completing an experience. Station panel 700 is also configured to transmit shout-out messages.

v. The IM panel

FIG. 8 is an exemplary screenshot of the IM panel. The IM panel 800 supports enhanced instant messaging. The IM panel 800 may consist of a sub panel containing the participants avatar 802, a sub panel displaying the avatar of their buddy with whom the participant is communicating 804, an inventory sub panel showing the participants inventory, a text conversation window 808, a buddy list 806 and a text entry window 810. The participant can communicate with the selected buddy by typing in the text entry window 810. Both the participants' messages and the buddy messages appear in the text conversation window 808. The participant's avatar and the buddy's avatar each appear on one another's desktop. Participants may control their avatar's animation and change their avatars clothing. Each change made to an avatar also appears on each buddy's desktop. The participants can engage in multiple conversations at a single time.

When communicating via the IM panel 800, participants may trade, lend, play experiences and shop with their buddy. For example, the trading panel allows the participants to offer, accept or reject items or bank points for trade. If both participants accept the trade, then the traded items are moved to the other players inventory.

vi. Multiparty IM panel

FIG. 9 is an exemplary screenshot of the Multiparty IM panel. The multiparty IM panel 900 supports enhanced multiparty chat. The multiparty chat IM panel 900 may consist of a sub panel containing the participant's avatar 902, an inventory sub panel showing the participant's inventory 914, a text conversation window (not shown in this exemplary panel), a text entry window 912, buddy avatar sub panels for each buddy in the multiparty chat 804 and second inventory display sub panel 916. The participants can communicate with the all buddies in the chat by typing in the text entry box 912. All of the participants' messages appear in the text conversation box. The participant's avatar 902 and the buddies' avatars 904 each appear in their respective sub panels and each buddy can control their avatar by changing clothes and typing animation commands. When in the multiparty IM panel 900 participants can trade 906, lend 908, play experiences 906 and shop 910 with their buddy as described with respect to the IM panel.

3. Shared Database

Returning to FIG. 3, the server side shared database 328 provides supports for the server side components including the game-play component 326, the player service component 338 and the IM server 358. Specifically, the shared database 328 stores information needed by these components. Like most databases, a schema is employed to organize the information in an efficient manner. Of course, numerous schemas may be employed to organize the necessary information, thus the schema description provided herein should not be construed as limiting.

The shared database 328 stores information concerning, among other things, anything that a player can buy or that may appear in the virtual store. Each of these entities is an item such as items of clothing, accessory items, animation items, and items used in the game. Multiple instances of any item may appear in the store or be owned by players but only one item is actually stored in the shared database. In other words, many references may be made to a single item. An item consists of information that specifically describes the item. For example, a clothing item may consist of the following data: a 3D model, a texture map, a text description, an iconic representation, the item's name, and meta data used by the 3D graphics process. The set of data varies by the type of the item such as the basic nude avatar model, clothing items, animation items and game items used during the experiences.

In addition to the items described herein, the database 328 stores information on each experience, how the experiences relate to each other, and information on each store including what items appear in the virtual store. The shared database 328 also stores player data for each role-playing participant which includes references to items such as the basic nude model, references to each model of clothing the player owns, references to each animation the player owns, deformation state of the model, and a wear order indicating what clothing the avatar is currently wearing. This data is constantly updated to reflect the player's current inventory.

Because the shared database houses fundamental data utilized by each client side system 302, it is necessary to make the data rapidly accessible so as not to burden the shared database 328. This is achieved by employing two techniques namely, sharing and caching/time-stamping.

a. Sharing

In the interest of efficiency, avatars use the same bodily components. However, users are allowed to deform their avatar according to their specification. Therefore, each avatar has unique deformation parameters which are stored as player data. For example, two avatars representing Alice and Barbara may use identical body components. These avatars nevertheless have their own “deformation” parameter thus allowing a single set of parameters to be stored per player record rather than the entire standard image (nude body components). Similarly, Alice and Barbara's avatars may own the same clothing item. Rather than storing a copy of the clothing item in the avatar's individual inventory, only a reference to the item is stored. For example, when Barbara and Alice become buddies Barbara's client will retrieve Alice's inventory and Alice's client will retrieve Barbara's inventory. If Alice's avatar owns a fleece pull-over the system must determine whether the fleece pull-over is an item in Barbara's inventory. If it is not in the inventory, the item will be uploaded to Barbara's inventory from the shared database 328. If, however, the fleece pull-over is found in Barbara's inventory then only a reference to the item needs to be placed in Alice's inventory. In addition, if the fleece pull-over in Barbara's inventory differs only in color from the fleece pull-over in Alice's inventory, only the texture map representing the different color will be uploaded. In other words, instead of storing a pink fleece pull-over and a blue fleece pull-over, the fleece pull-over model is stored once and the different texture maps are stored. As such, in Barbara's player inventory there are references to the data that described a blue fleece pullover. This information consists of a reference to a 3D model and a texture map among other data as described herein. In Alice's player inventory, a copy of which is located in Barbara's local database, there are references to the data that described the pink fleece pull-over. This information also consists of a 3D model and a texture map among other data. In both cases the reference to the 3D model is the same but the references to the texture maps are different, one is blue and one is pink. As such, the 3D model data is only stored once.

b. Caching and Timestamping

Returning again to FIG. 3, the client side of the player inventory sub-system 330 maintains a client cache database 334. The cache database 334 acts as a smaller and faster subset of the shared database 328 by holding frequently accessed data thus saving the system from inefficient retrievals to the shared database 328. Inherently, utilizing a client side cache database 334 is orders of magnitude faster than relying solely on the shared database 328 over the network.

The following is a non-limiting example explaining how the client cache database 334 is synchronized with the shared database 328. Upon start-up, Alice's computer transmits a remote procedure call to the server requesting that her corresponding player record be retrieved from the shared database 328. The player record contains a timestamp (“PlayerModTime”) indicating the most recent modification. A modification to the player record may occur when parameters associated with the player change. This may include, but is not limited to, a change in the player's avatar or a change in the avatar's clothing. Alice's player record also contains a timestamp (“PlayerInventoryModTime”) indicating when Alice's inventory last changed. A change of this nature occurs when, for example, Alice purchases clothing or completes an experience. Additionally, each inventory item may also include a timestamp that indicates when it was created or changed.

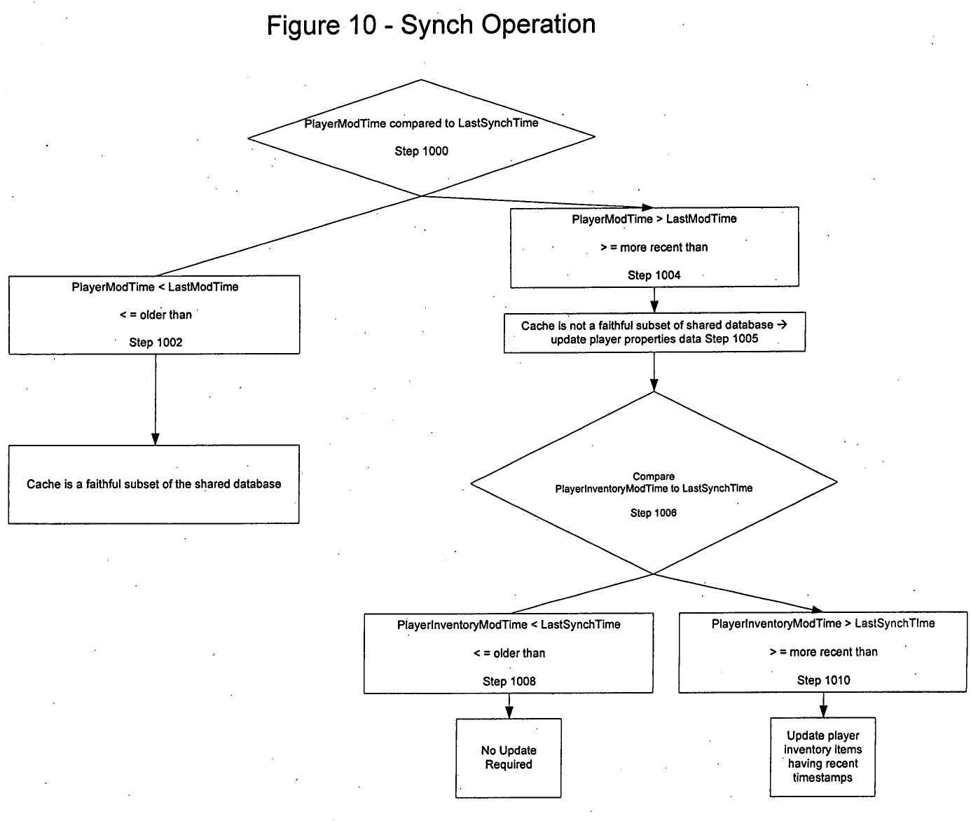

To ensure that the client cache database is up to date, the cache database must be synchronized with the shared database. FIG. 10 is a flow chart illustrating this synchronization process. As shown in step 1000, the PlayerModTime timestamp is compared against a “LastSynchTime” timestamp stored in the client copy of the database. The LastSynchTime indicates the time of the last synchronization attempt. If, in step 1002, the PlayerModTime timestamp is older than the LastSynchTime timestamp, the client cache is determined to be a faithful copy of the shared database. If, however, the PlayerModTime timestamp is not older than the LastSynchTime timestamp as shown in step 1004, the client cache is not a faithful subset and must be updated from the shared server. As such, the players avatar data and certain other player properties are updated in step 1005. In step 1006, the PlayerInventoryModTime timestamp is compared against LastSynchTime. If, in step 1008, the PlayerInventoryModTime timestamp is older than the LastSynchTime timestamp, updating is not required. If, however, the PlayerInventoryModTime timestamp is more recent than LastSynchTime timestamp in step 1010, the server side shared database is queried to transmit all player inventory items having timestamps that are more recent than LastSynchTime to the client cache database. For example, if Alice took the shoes off her avatar, only the player inventory item row for the shoes would be retrieved, not the other records that completely describe the item. The retrieved reference to the player inventory item is then stored in the client cache database.

4. System Communication

As described herein with respect to FIG. 3, client/server communications of system 300 may be broken down into three main categories. First, as part of the game-play sub-system 320, the embedded browser provides a client interface for browsing through stores, purchasing inventory, trading items, playing “experiences,” etc. The embedded browser uses HTML to display the data communicated over HTTP to accomplish these functions. HTML over HTTP conforms to the classic “e-commerce” paradigm, whereby a customer can browse for and purchase items using HTML generated by the server from its database.

Second, as part of the player inventory sub-system 330, the client cache database 334 is synchronized with the server side shared database 328 using SOAP over HTTP. Finally, as part of the IM sub-system 350, the client side instant messaging components use the XML-based Jabber (XMPP) protocol to communicate with the IM server 358 and with other players' clients 360. The server components, particularly the game play component 336, may also initiate communication with a client via the Jabber server 358, using the Jabber (XMPP) protocol.

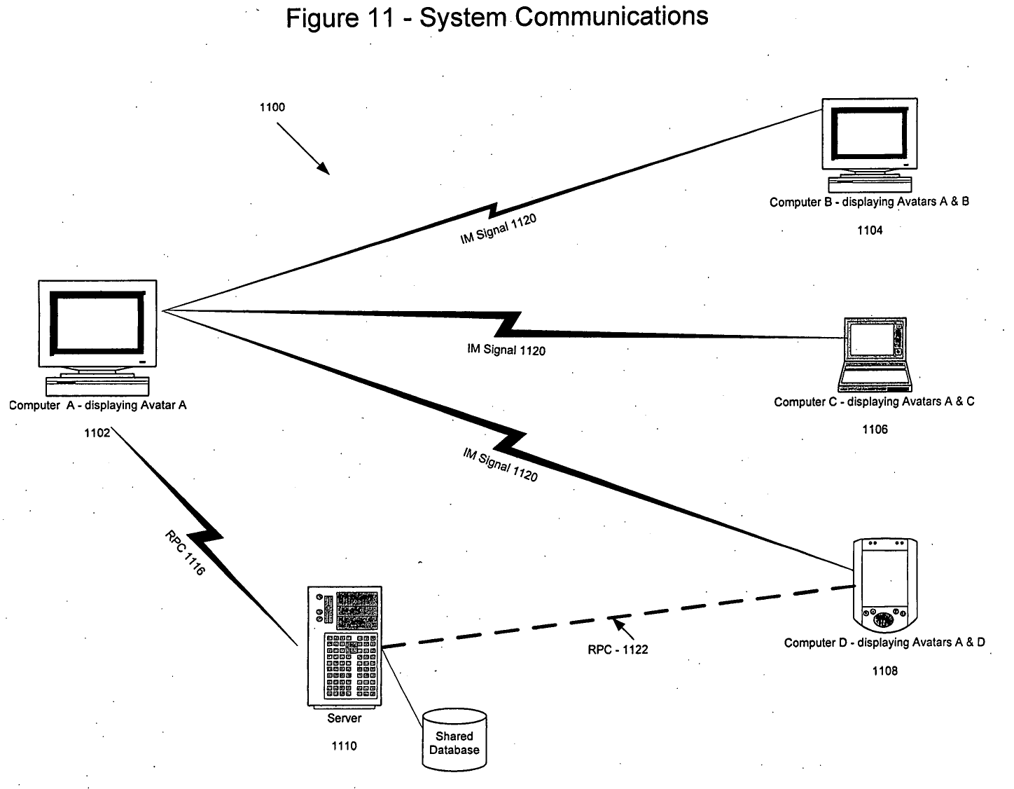

FIG. 11 is a diagram illustrating the logical communication between network devices configured to implement the virtual gaming environment of the present invention. The network 1100 consists of computer A 1102 in communication with device B 1104, device C 1106, device D 1108 and a server 1110. As further shown, the avatar associated with computer A 1102 is also displayed on each device in communication with computer A 1102. Therefore, the computer screen of device B 1104 depicts its own avatar and the avatar of computer A 1102. Similarly, device C 1106 and D 1108 each depict their own avatar and the avatar of computer A 1102. It is important to note that the gaming environment of the present invention may be executed on various devices including but not limited to computers, wireless devices, phones, PDAs and set-top boxes.

The following non-limiting example illustrates how the devices communicate. More specifically, the example illustrates the communication required to reflect a change made to computer A's 1102 avatar on the other devices in communication with computer A. As explained herein, a user may uniquely change an avatar's appearance by deforming physical characteristics or changing the dress of the avatar. For example, the user of computer A 1102 may decide to place a new pair of shoes from her inventory on the avatar. Once the item is retrieved from her player inventory, the graphics component will render the request and display on computer A 1102.

Upon changing the avatar's appearance on computer A 1102, at least two other functions must be performed. First, the player inventory associated with computer A's 1102 avatar must reflect the change. Second, the devices in communication with computer A 1102 must be informed of the change so the newly changed avatar is properly reflected on those devices.

Returning now to the first function, the player inventory record must be changed such that the player inventory reflects that the shoes are now being worn. This change may be reflected in both the computer's cache database and the server's shared database. With respect to the cache database, this change is accomplished via the user interface component which causes the changed player inventory item to be reflected in the cache database. The cache database component will ensure this change is written through to the shared database. Specifically, the user interface causes the client cache database to update itself. The client database is smart enough to know that if it updates itself it needs to get player services component to update the shared database, assuming an on-line connection is present. If the client is offline, then the update occurs at the next synchronization time.

To change the record of the shared database, the computer transmits an update request 1116 via a remote procedure call to the server. The update request 1116 can be encoded using SOAP, or another protocol, and transmitted to the player services component. The player services component ultimately authenticates, validates and performs the request.

Upon updating the shared and local databases, each device displaying computer A's 1102 avatar will be notified of the change. This is accomplished using instant messaging as the communication platform. After making such a change, Alice's client then sends an instant message signal to everyone with whom she is communicating. This “back-channel” instant message signal is sent to everyone with whom computer A 1102 is communicating In general, the instant message signal indicates to those communicating with computer A 1102 that something about computer A's 1102 avatar has been changed and thus must be reconstructed on devices B 1104, C 1106 and D 1108.

This concept is explicitly illustrated in FIG. 11. As depicted, when computer A 1102 changes the appearance of its avatar, instant messaging signals 1120 are transmitted to the other devices (i.e.; 1104, 1106 and 1108) that are in communication with and displaying computer A's 1102 avatar. The instant messaging signal is a non-text Jabber message that employs a common Jabber technique wherein an extended XML packet is included in a message. The extended XML packet incorporates a code that tells the receiving software executing on devices B, C and D (1104, 1106 and 1108) to refresh their copy of the computer A's 1102 inventory.

Upon receiving the instant messaging signal, the receiving devices (1104, 1106 and 1108) then cause the player inventory associated with computer A's 1102 avatar in their local database (cache) to synchronize with the shared database. The inventory will be changed to reflect that the shoes are now being worn by the avatar and the 3 D graphics process will cause the avatar to be redrawn to reflect the new shoe selection.

As explained herein, the instant messaging platform allows the distributed devices to communicate in an efficient manner. As such, instant messaging is the communication format used to communicate between clients and other clients and servers to clients. It should be noted that the instant messaging may be used by the server 1110 to send non-text messages to a client computer 1102. For instance, the server 1110 may send an instant messaging signal to a client computer when new points are allocated asking the client computer to refresh its inventory.

D. 3D Graphics Process

The unique 3-D graphics process used by the present invention allows participant's to change their avatar's clothes by uniquely slicing away large regions of the underlying avatar as clothing is added. This processes advantageously minimizes the polygon count and removes underlying layers so that the system does not try to render two or more sets of polygons over each other which may cause bleed through. Additionally, the 3-D graphics process is a novel deformation system in that the avatar and clothing are deformed by the influence of strategically placed geometric objects, typically called bones. As explained in greater detail herein, these geometric objects or bones define a spatial influence function that affects vertices near the objects. Therefore, both avatar vertices and clothing vertices fall under the influence of these objects. As the objects move, rotate, or scale, the surrounding avatar and clothing vertices also move in proportion to the influence. As such, both the body and clothing behave in the same manner during deformation. The appearance to the participant is that as they change the avatar's features, the clothes automatically conform.

Once the database query identifies the avatar's parameters and the player inventory items currently associated with the avatar, the model data for each component is retrieved from the database and submitted to the 3-D graphics process for display. A computer's graphics system displays information on a computer monitor by periodically updating the screen. The rate at which this update takes place is called the “frame rate.” For each update, or frame, a sequence of processes take places. In the 3D graphics system, there are three stages associated with presenting visual 3D data. The first and second stages are directed to the preparation of the 3D data while the third stage is associated with the displaying (or rendering) the prepared data on the computer monitor. The third stage may use any number of available software and system products to render these images. For example DirectX libraries or OpenGL may be used to send the 3D data, prepared in the first and second stages described herein, to the graphics card for processing and subsequent monitor display. As such, the third stage of the graphics process uses display and rendering techniques common to numerous existing 3D applications.

The data preparation processes that occurs before a complete avatar is rendered consist of a set of processes that are performed infrequently, and a set of processes that must be frequently performed for each frame, many times per second. Infrequent data preparation is triggered when the participant invokes certain actions, including but not limited to, placing or changing clothes on the avatar or modifying the avatar's facial features using a face-changing slider. When any of these actions are performed, the underlying 3D data is changed until the user performs this action or a similar action again. When infrequent data preparation is invoked (by such above described actions), a complete set of processes is performed for the 3D models that makes up the clothed avatar. These models may include, but are not limited to, the basic nude model and each separate clothing item currently being worn by the avatar.

For example, an avatar clothed in a halter top, shorts and shoes includes eight separate but coordinated 3D models that must be processed (e.g.: halter, shorts, shoes, body, eyes, mouth, hair, eyelashes). These infrequent data preparation processes include 1) preparation of the body, slicing it for the appropriate clothes, applying deformation parameters, 2) preparation of the eyes (facial deformations), 3) preparation of the mouth (facial deformations), 4) preparation of the clothing (body deformations), 5) preparation of the hair and 6) preparation of the eyelashes. It is important to note that this order is designated for transparency purposes. Those items that are not transparent are processed first including the body, eyes and mouth. Those items that are more transparent are subsequently performed. For example, hair may be processed after the clothing because hair often covers the clothing and thus has transparent aspects. Similarly, the eyelashes may be processed after the hair because at certain angles, the eyelashes may overlay the hair. The resulting data is then stored in a buffer to be used by the frequent data preparation processes.

Frequent data preparation, on the other hand, includes data preparation that is required for every frame including, but not limited to, animating the avatar when indicated by the participant. During frequent data preparation, the model undergoes the following processes for each frame: 1) applying a buffer of facial and body morphs maintained in the deformer system which gives the avatar the customized look, 2) facial animation via the deformer system, 3) body animation via the body animation system, 4) rendering preparation and BSP processing and 5) DirectX rendering. Each of these processes are described in greater detail herein.

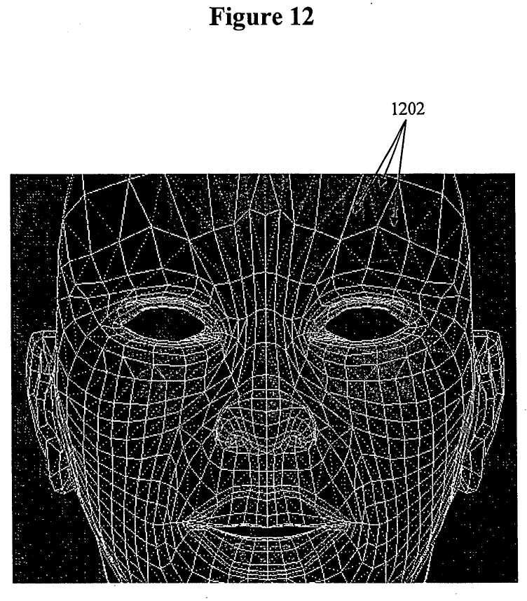

Data preparation, whether infrequent or frequent, begins with raw 3D data. 3D data is composed of geometric data, texture data and animation data, and auxiliary data specific to the requirements of graphics process described herein. The geometric, texture and animation data formats are standard industry formats. For example, geometric data is stored as a set of connected triangles. FIG. 12 is an exemplary illustration of a model diagrammed using geometric data. As illustrated, the facial model is made up of a set of connecting triangles 1202. Each model in the graphics processing system is constructed in this manner.

Texture map data may be stored in a conventional bitmap image format including but not limited to a .jpg, .bmp, .tga, or other standard file format. Texture data consists of a colored planar drawing wherein each triangle 1202 (or polygon) is mapped to a specific place on the drawing and given that particular color. A texture map has been applied to the facial model shown in FIG. 12 as illustrated by the color texture. Each model may be associated with at least one texture file. Furthermore, standard animation data formats may be used to make the avatar move.

In addition to these data formats, the graphic process of the present invention also utilizes unique data formats including but not limited to: 1) morph target data used to deform the face in response to the participant moving a slider, 2) facial animation data used for facial animations, 3) body deformation data which allows clothing to be deformed along with the body, 4) slicer data for defining where the nude 3D model should be “cut” in order to remove triangles and 6) transparency data that enables proper display of items that exhibit transparent or semi-transparent qualities.

a. Infrequent Data Preparation

1. Body Model Slicing

As described herein, infrequent data preparation is triggered when the participant invokes certain actions such as placing or changing clothes on the avatar. However, before the avatar can be rendered and displayed wearing the new clothing item, the nude body model must have sections of triangles removed. Two serious problems are encountered in the absence of this step. First, the number of polygons being sent to the graphics card becomes unmanageably high. Second, even if the polygon count were not an issue, bleed-through of the body through the clothes from both quantum z-buffer errors and imprecise skin weighting on the vertices produces unacceptable visual anomalies.

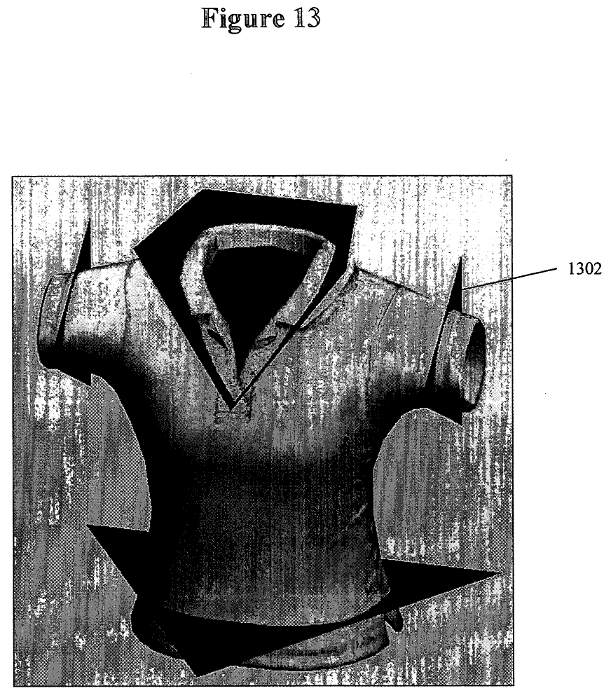

Therefore, to overcome this effect, each object (e.g.: clothing, shoes, and hair in some cases) contains auxiliary non-renderable geometry called “slicers.” These slicers are simple geometric objects, in many cases just single triangles or rectangles, although any object may be used. The slicers are placed at strategic points around the object such as the ends of sleeves of a shirt, around colors, or at the tops of the shoes. The slicers serve as knife edges that intersect the avatar's body. FIG. 13 is an exemplary illustration of slicers positioned around points of a shirt. Specifically, the slicers 1302 are used to define regions of geometry on the body that can be safely removed. Specifically, a slicer is a mathematical description of a geometric object. The graphics process computes where these slicers intersect the body model similar to computing where two planes intersect. This information is then used to remove the triangles of the body that will be covered by the matching clothes.

Because clothing shape varies, it is not practical to create a system that will slice nicely on body triangle edge boundaries. Therefore, the slicers assume nothing and actually cut through the body triangles at arbitrary places, creating new triangles and vertices in the process. Texture mapping coordinates and skin weights are interpolated for any new vertices. After slicing, body geometry that is hidden by the clothing can be completely removed. It is important to note that the slicer objects are constructed by an artists for each piece of clothing and are therefore unique for each clothing model.

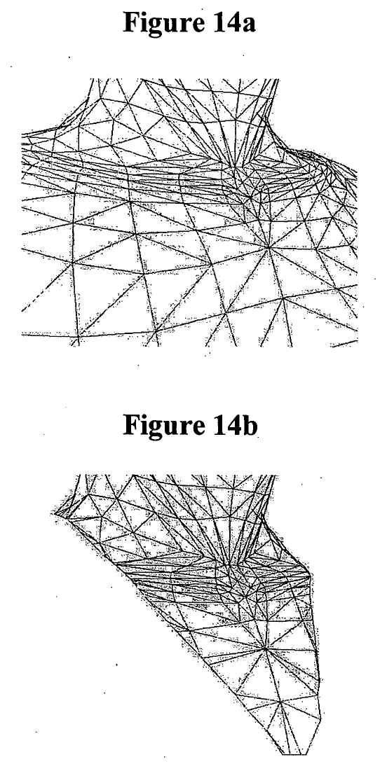

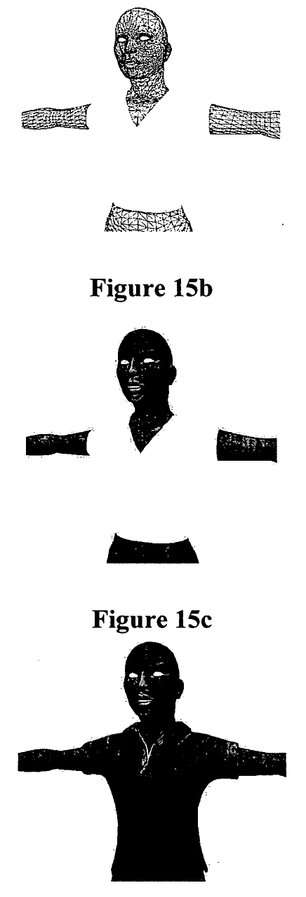

During the infrequent preparation stage, these slicers will cut the nude model and all nude model geometry that is within the slicing region will be discarded. FIGS. 14a and 14b are graphical illustrations of a nude avatar model bisected by slicers. As shown in FIG. 14a, triangles are bisected by the slicers, thus creating new triangles. FIG. 14b illustrates the nude model after being sliced. The data that is associated with data for texturing and animating the nude model is then interpolated to include the new triangles. FIGS. 15a-15c illustrate the shirt model and avatar model being rendered together. As shown in FIG. 15a, the nude model has been sliced by the shirt slicers shown in FIG. 13. FIG. 15b illustrates the avatar model with the removed region. Finally, FIG. 15c illustrates the avatar model being rendered together with the shirt model.

In summary, in order to enable a participant to change an avatar's clothing, the graphics process of the present invention stores the deformations, slices the standard model, replaces the sliced portions with clothing models and then re-applies the deformations. When clothing is placed over clothing the underlying clothing layers are similarly sliced and removed.

2. Deformer System

The graphic process of the present invention includes a model deformer system. The deformer system is used for both infrequent and frequent data processing. During infrequent processing, the deformer system responds to user interaction and sets up data buffers. During frequent processing, these data buffers are applied to the avatar.

All facial morphs, body morphs, and facial animations are performed in the deformer. The deformer order is as follows:
1. Facial morphs (infrequent)
2. Body morphs (infrequent)
3. Facial animations (frequent)

A two level buffering system is used by the deformer. The first level buffers all the facial morphs and body deformations; the second level buffers the data from the first level buffer plus the facial animation state.

i. Facial Morphs

Facial morphs are processed by the deformer first. Each morph target is applied according to the value of its corresponding slider. Morph targets are a standard 3D graphics technique used to change the appearance of some object such as, a facial feature. By way of explanation, a feature such as a nose is drawn in an initial position and each vertex in the set of triangles has a spatial description for this position. A morph target is, for example, the nose in some altered position (perhaps wider). As such, each of the same triangles has a new morphed position. When the user moves a slider, the deformer performs linear interpolation for each vertex between the original position and the altered position depending on the position of the slider Facial morphs are calculated when the user moves a facial morph slider and thus the conglomerate morph state buffer (level one) is updated during infrequent data preparation. Although the system calls the deformer for each frame (frequent data preparation), the buffered morph state will be block copied to the second level buffer and not recomputed when there is no change in a slider value. It is important to note that even though facial morph calculations are streamlined to only affect vertices that actually move, the buffer applies to the entire model. This way the bones deformer below can write to the same buffer.

ii. Body Morphs (Bones Deformer)

Body morphs are performed second. When a slider is moved, a geometric object called a bone is moved accordingly, for example out and in as the width of the thighs are changed. As the bone is moved, the positions of the triangle vertices in the thigh description are moved according to a mathematical formula weighting its distance from the bone. Each bones deformer is applied according to the value of its corresponding slider and the data is buffered along with the facial morph data in the level one buffer. As for facial morphs, when a body slider is not being moved, the vertex data affected by its bone will not be recomputed and the corresponding buffer data will not be altered.

b. Frequent Data Preparation

1. Deformer System

The deformer system is used in both frequent and infrequent data processing. For each frame, the level one buffer that was prepared when making infrequent changes is then copied to the level two buffer. If there is no facial animation taking place, the full level two buffer is applied to the model. If facial animation is taking place, the facial animation data is applied to the level two buffer.

In the deformer system, as part of facial animation, special processing may also be performed for the eyeblinks. A single eyeblink animation is not compatible with morph targets that change the structure of the eyes. By way of example, if the eyes are enlarged, they will not completely close. If the eyes are shrunk, the lids will overrun their closed positions. As such, the solution is to create an eyeblink animation from the neutral model and one from each extreme of the eye-related morph targets. The correct eyeblink animation will be the result of blending these animations in accordance with the morph target percentages. This blending needs to be done only when the sliders are moving. The data generated as a result of the blending is equivalent to having read up an animation file.

The deformer system is also configured to blend the final state of an animation with the initial state of an animation. Thus, if an animation is requested, the model transitions smoothly from its current state to the new animation.

2. Body Animations

Body animations are performed via standard methods for 3D avatar animation. Information is provided from the animation files for moving the bones used in performing the body animation and the vertices of the triangles describing the body in relation to the bones.

3. BSP Processing

As mentioned herein, some items, such as hair, contain random transparency regions and are typically static. Using a Binary Space Partition (BSP) tree is a standard graphics technique for drawing 3D objects triangles from back to front relative to a users view, to ensure that the right parts of the object are shown and hidden for the view. Therefore, hair items are treated with a BSP back to front structure that encompasses the entire model. In contrast, clothing may contain random transparency regions, but during animation, regions of clothing move with respect to each other. For example, the avatar's forearm might block the view of the opposite forearm, then move to block the view of the opposite bicep. This all depends on the specific animation and the camera perspective. Standard BSP back to front rendering for this situation does not work, since the BSP structure itself changes every frame. To circumvent this problem, we combine standard BSP processing with coarse region sorting, described below.

4. Clothes Rendering

Clothes rendering works on coarse region sorting, followed by BSP sorting. This process involves breaking up a clothing model into regions that move as a block. Take for instance, the bicep area verses the forearm area. During animation, each of these areas move, but there is no movement within each area. BSP data is therefore defined by each region. As the avatar animates, the regions are sorted in front to back order from the camera, then standard BSP sorting within each region is performed.

5. DirectX Rendering

DirectX rendering is performed by standard DirectX dynamic buffer procedures for speed. Specifically, for models requiring BSP front to back calculations, triangles are not sent to the renderer one at a time for processing. Rather, for each BSP tree, a front to back array of triangle indices are generated and the entire array is then sent to DirectX. This results in much faster rendering. As noted herein, any rendering software or system may be used in conjunction with the graphics process of the present invention. Therefore, the exemplary use of DirectX as the rendering package should not be construed as limiting.

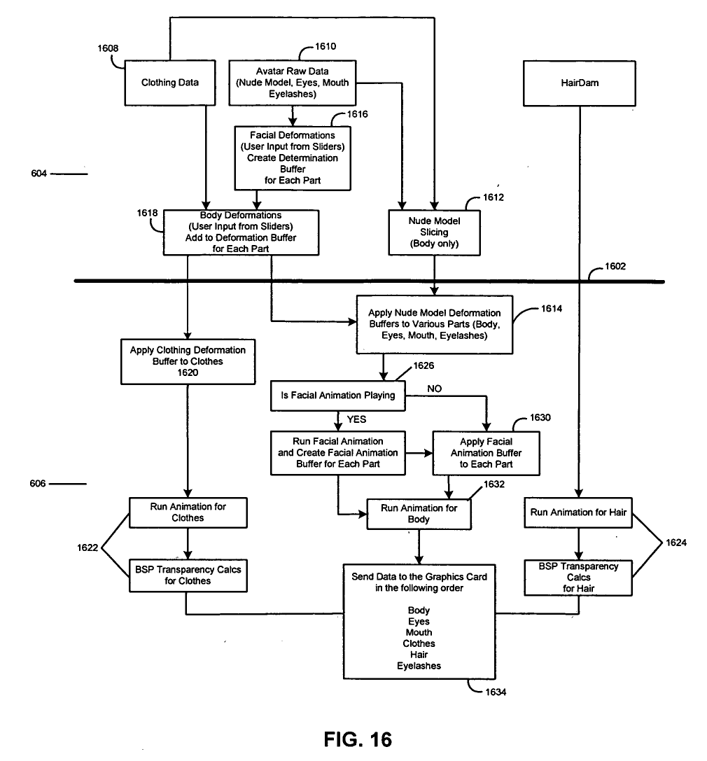

FIG. 16 is an exemplary flow diagram illustrating frequent and infrequent data preparation. As shown, the line 1602 across the middle of the flow diagram separates the frequent data processes 1606 from the infrequent data processes 1604. Specifically, all process above the line are preformed infrequently while the processes shown beneath the line are performed frequently.

The graphics process starts with the nude model having eyes, a mouth and eyelashes, in addition to separate clothing models, hair and accessory models. The slicing data from the clothing model 1608 is sent with the nude model body data 1610 to the nude model slicing box 1612. The nude model slicing 1612 then removes the appropriate triangles and places this information in a buffer 1614 for body rendering. The nude model body data 1610 is also sent to the facial deformation box 1616 wherein the facial deformation is computed. The model, along with the clothing model 1608, is then sent to the body deformation box 1618. The body deformations are applied to all the clothing models and the nude model. The results of applying the deformations are stored as parameters in the buffers for clothing deformations 1620 and body deformations 1614.

As noted the operations involving frequent data preparation are illustrated below line 1602 and are performed for each frame. The results are then displayed using the renderer. New animation data is also created for every frame so that the models move and give the illusion of animation. Body animation calculations are applied to the deformed clothing models 1620, they are then sorted using the BSP technique 1622 and sent for rendering 1634. The hair uses a similar process as illustrated by step 1624. The facial animations are applied to the facial system 1626 using the same deformer that was used to deform the model in the infrequent data preparation phase. Facial animation is similar to facial deformation so the systems are similar. However, the facial deformations are only performed when the user changes the avatars facial features while the facial animations are performed on a per frame basis when an animation is initiated.

The facial animation is applied as discussed herein. After the facial animation changes are applied 1630, the body animation computations 1632 are performed. The last step is to render 1634 all of the data in a specific order so that the sorting is preserved and the right parts of the avatar and body are displayed or covered. As illustrated in FIG. 16, the order is as follows: body, eyes, mouth, clothes hair and eyelashes.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other electronic devices suitable for the purposes described herein.

Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Screenshots presented and described herein can be displayed differently as known in the art to input, access, change, manipulate, modify, alter, and work with information.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for obtaining data comprising:
a) providing a simulated market economy participated by a plurality of participants and supported by an instant messaging platform;
b) enabling at least one of the plurality of participants to obtain a virtual resource available from the simulated market economy;
c) generating a signal which indicates that the at least one of the plurality of participants has obtained the virtual resource;
d) transmitting the signal to at least one other of the plurality of participants through the instant messaging platform; and
e) collecting data regarding a behavior of the at least one of the plurality of participants in the simulated market economy.

2. The method of claim 1, wherein step e) comprises collecting data regarding usage of the virtual resource by the at least one of the plurality of participants.

3. The method of claim 2, wherein the virtual resource comprises a virtual currency.

4. The method of claim 2, wherein the virtual resource comprises a virtual item that simulates an item offered for sale by a real merchant.

5. The method of claim 1, wherein step e) comprises collecting aggregated data regarding the behavior of the plurality of participants in the simulated market economy.

6. The method of claim 1, further comprising enabling the at least one of the plurality of participants to create an avatar to represent the participant in the simulated market economy.

7. The method of claim 6, further comprising enabling the at least one of the plurality of participants to control the avatar.

8. The method of claim 1, further comprising enabling the at least one of the plurality of participants to create and control an avatar to represent the at least one of the plurality of participants and wherein step e) comprises collecting data relating to preferences of the at least one of the plurality of participants displayed through an appearance of the avatar as controlled by the at least one of the plurality of participants.

9. The method of claim 8, further comprising enabling the at least one of the plurality of participants to control a facial expression of the avatar.

10. The method of claim 8, further comprising enabling the at least one of the plurality of participants to control a bodily movement of the avatar.

11. The method of claim 8, further comprising enabling the at least one of the plurality of participants to control the avatar by changing an item of clothing worn by the avatar.

12. The method of claim 8, further comprising enabling the at least one of the plurality of participants to control the avatar by changing an accessory worn by the avatar.

13. The method of claim 8, further comprising enabling the at least one of the plurality of participants to store in an inventory at least one virtual resource used to control an appearance of the avatar.

14. The method of claim 1, further comprising enabling the at least one of the plurality of participants to create an avatar to represent the participant in the simulated market economy and subsequently change an appearance of the avatar, and wherein step b) comprises enabling the at least one of the plurality of participants to obtain a virtual resource used to create and change an appearance of the avatar, and step c) comprises generating a signal indicative of the change in an appearance the avatar and transmitting such signal to the at least one other of the plurality of participants through the instant messaging platform.

15. The method of claim 14, further comprising prompting a client terminal used by the at least one other of the plurality of participants to participate in the simulated market economy to automatically update and display the avatar with the change in appearance.

16. The method of claim 1, further comprising enabling the at least one of the plurality of participants to create an avatar to represent the participant in the simulated market economy and to store in an inventory at least one virtual resource used to control an appearance of the avatar and wherein step (e) comprises collecting data regarding the virtual resource stored in the inventory.

17. The method of claim 6, further comprising enabling the at least one of the plurality of participants to engage in a transaction involving a virtual resource with the at least one other of the plurality of participants.

18. The method of claim 6, further comprising enabling the avatar to engage in an experience.

19. The method of claim 1, further comprising enabling the at least one of the plurality of participants to collect virtual currency by accomplishing a specific task.

20. The method of claim 19, wherein accomplishing a specific task comprises playing a game.

21. The method of claim 1, further comprising providing an incentive for the at least one of the plurality of participants to recommend to at least one other individual to participate in the simulated market economy.

22. The method of claim 21, further comprising enabling the at least one of the plurality of participants to send an installation file necessary to participate in the simulated market economy to the at least one other individual.

23. A method for obtaining data comprising:
a) providing an on-line interactive community which simulates a market participated by a plurality of participants, in which at least two virtual merchants offer for sale a plurality of virtual items;
b) enabling at least one of the plurality of participants to obtain one of the virtual items, thereby displaying a preference for the obtained virtual item; and
c) collecting data regarding which virtual items have been obtained by the at least one of the plurality of participants.

24. The method of claim 23, further comprising enabling the at least one of the plurality of participants to create an avatar to represent the participant in the on-line interactive community.

25. The method of claim 24, further comprising enabling the at least one of the plurality of participants to control the avatar.

26. The method of claim 25, further comprising enabling the at least one of the plurality of participants to store in an inventory at least one virtual item used to control an appearance of the avatar.

27. The method of claim 23, further comprising enabling the at least one of the plurality of participants to create an avatar to represent the participant in the on-line interactive community and subsequently change an appearance of the avatar, and wherein step b) comprises enabling the at least one of the plurality of participants to obtain one of the virtual items used to create and change an appearance of the avatar.

28. The method of claim 27, further comprising generating a signal indicative of the change in the appearance the avatar and transmitting such signal to the at least one other of the plurality of participants through an instant messaging platform.

29. The method of claim 28, further comprising prompting a client terminal used by the at least one other of the plurality of participants to participate in the on-line interactive community to automatically update and display the avatar with the change in the appearance.

30. A method for obtaining data comprising:
a) providing a simulated market participated by a plurality of participants;
b) enabling at least one of the plurality of participants to create an avatar to represent the participant in the market;
c) enabling the at least one of the plurality of participants to collect a plurality of virtual resources used to control an appearance of the avatar; and
d) generating a signal indicative of a change in the appearance of the avatar;
e) transmitting the signal to at least one other of the plurality of participants through an instant messaging platform;
f) prompting a client terminal used by the at least one other of the plurality of participants to participate in the simulated market to automatically update and display the avatar with the change in the appearance; and
g) collecting data regarding the plurality of virtual resources collected by the at least one of the plurality of participants.

31. The method of claim 30, wherein step g) comprises collecting data regarding usage of the virtual resource by the at least one of the plurality of participants.

32. The method of claim 30, wherein step g) comprises collecting aggregated data regarding a behavior of the plurality of participants in the simulated market.

33. The method of claim 30, wherein step g) comprises collecting data relating to preferences of the at least one of the plurality of participants displayed through an appearance of the avatar as controlled by the at least one of the plurality of participants.

34. The method of claim 30, wherein step c) comprises enabling the at least one of the plurality of participants to control a facial expression of the avatar.

35. The method of claim 30, wherein step c) comprises enabling the at least one of the plurality of participants to control a bodily movement of the avatar.

36. The method of claim 30, wherein step c) comprises enabling the at least one of the plurality of participants to control the avatar by changing an item of clothing worn by the avatar.

37. The method of claim 30, further comprising enabling the at least one of the plurality of participants to store in an inventory at least one of the plurality of virtual resources used to control the appearance of the avatar.

38. A system for obtaining data comprising:
a) a module configured to enable a first participant of a plurality of participants in a simulated market economy to obtain a virtual resource available from the simulated market economy;
b) an instant messaging platform configured to convey to a second participant of plurality of participants a message which indicates that the first participant has obtained the virtual resource; and
c) a server configured to collect data regarding a behavior of the first participant.

39. The system of claim 38, further comprising a second module configured to enable the first participant to create an avatar to represent the first participant.

40. The system of claim 39, wherein the second module enables the first participant to control the avatar.

41. The system of claim 40, wherein the second module enables the first participant to control a facial expression of the avatar.

42. The system of claim 40, wherein the second module enables the first participant to control a bodily movement of the avatar.

43. The system of claim 40, wherein the second module enables the first participant to change an item of clothing worn by the avatar.

44. The system of claim 40, further comprising a third module for storing at least one virtual resource used to control an appearance of the avatar.

45. The system of claim 44, wherein the at least one virtual resource comprises a clothing item for the avatar.

46. The system of claim 44, wherein the at least one virtual resource comprises an accessory for the avatar.

47. The system of claim 44, wherein the server collects data regarding the virtual resource stored in the third module.

48. The system of claim 40, further comprising a fourth module which enables the avatar to engage an experience.

49. The system of claim 38, wherein the server is configured to collect data regarding usage of the virtual resource by the participant.

50. The system of claim 38, further comprising a second module configured to enable the first participant to create and control an avatar to represent the first participant and wherein the server collects data relating to preferences of the first participant as displayed through an appearance of the avatar controlled by the first participant.

51. The system of claim 38, wherein the server is configured to collect aggregated data regarding the behavior of the plurality of participants in the simulated market economy.

52. The system of claim 38, further comprising a second module configured to enable the first participant to purchase a real item from a real merchant.

53. A system for obtaining data comprising:
a) a module configured to enable a first participant of a plurality of participants in an on-line interactive community which simulates a market, in which at least two virtual merchants offer for sale a plurality of virtual items, to obtain one of the virtual items, thereby displaying a preference for the obtained virtual item; and
c) a server configured to collect data regarding which virtual items have been obtained by the first participant.

54. The system of claim 53, further comprising a second module configured to enable the first participant to create an avatar to represent the first participant.

55. The system of claim 54, wherein the second module enables the first participant to control the avatar.

56. The system of claim 55, further comprising a third module for storing at least one virtual resource which is used to control an appearance of the avatar.

57. A system for obtaining data comprising:
a) a first module for enabling a first participant of a plurality of participants to create an avatar to represent the participant in a simulated market;
b) a second module for enabling the first participant to collect a plurality of virtual resources from the simulated market for use in controlling an appearance of the avatar; and
c) a third module for generating a signal indicative of a change in the appearance of the avatar;
d) an instant messaging platform configured to transmit the signal to a second participant of the plurality of participants, thereby prompting a client terminal used by the second participant to automatically update and display the avatar with the change in the appearance; and
e) a server configured to collect data regarding the plurality of virtual resources collected by the first participant.

58. The system of claim 57, wherein the second module enables the first participant to control a facial expression of the avatar.

59. The system of claim 57, wherein the second module enables the first participant to control a bodily movement of the avatar.

60. The system of claim 57, wherein the second module enables the first participant to change an item of clothing worn by the avatar.

61. The system of claim 57, further comprising a fourth module for storing the plurality of virtual resources.

62. The system of claim 57, wherein the server is configured to collect data regarding a usage of the plurality of the virtual resources by the first participant.

63. The system of claim 57, wherein the server is configured to collect data relating to preferences of the first participant as displayed through an appearance of the avatar controlled by the first participant.
